(19) United States
(12) Patent Application Publication
(10) Pub. No.: US 2004/0049414 A1
(43) Pub. Date: Mar. 11, 2004

(54) Apparatus and method for sharing information related to a continuous process improvement project

(76) Inventors: James F. Gibson, Edwards, IL (US); Larry J. Knapp, Eureka, IL (US); Allan F. Silzer, Peoria, IL (US); Howard E. Sweetin JR., Peoria, IL (US)

Correspondence Address: CATERPILLAR INC., 100 N.E. ADAMS STREET, PATENT DEPT., PEORIA, IL, 616296490

(21) Appl. No.: 10/117,647

(22) Filed: Apr. 5, 2002

(51) Int. Cl. G06F 17/60

(52) U.S. Cl. 705/7

(57) ABSTRACT

A system and method for sharing information relating to the status of a continuous process improvement project of a business operation between a plurality of remote sites and a central location. The remote sites communicate with the central location on a computer network via a communications data link. The central computer at the central location stores a form which is accessible by the remote computer at each of the plurality of remote sites over the communications data link. Project information input into the form at one of the plurality of remote sites is relayed to the central location over the communications data link. Access to the information is provided to the plurality of remote sites.

### TECHNICAL FIELD

The present invention related generally to an apparatus and method for sharing information related to a continuous process improvement project and, more particularly, to a system and method for relaying information from a plurality of remote sites to a central location and sharing information related to a project between the plurality of remote sites and the central location.

### BACKGROUND

Electronic mail has been the primary means for reporting changes, improvements and best practices from the results of dealer process continuous improvement team efforts. However, inconsistent data entry and format and a lack of data entry are a result of using electronic mail for this purpose. For example, the data may be received on a form via facsimile or by mail or electronically in different document formats. As a result, data integration and sharing of data between various segments of a business operation become extremely difficult.

Moreover, substantial delays associated with tracking and viewing improvement and best practice reports on projects from start to finish are a result of the present method of continuous process improvement in a business entity. Many of the existing systems do not allow dealers and individuals who are working on the same type of project to track the progress or methods used on a similar project until the project is fully completed. Consequently, an entity is prevented from taking advantage of a more efficient method of doing business and improving similar work on a similar project, thereby minimizing or prohibiting cost savings realized by the entity and its customers.

The present invention is directed at solving one or more of the problems as set forth above.

### SUMMARY OF THE INVENTION

In one aspect of the present invention, a method for sharing information relating to the status of a continuous process improvement project of a business operation between a plurality of remote sites and a central location is provided. The method includes the steps of providing at least one form from the central location on a computer network to the plurality of remote sites over a communications data link, relaying project information input into the form at one of the plurality of remote sites to the central location over the communications data link and providing access to the project information to the plurality of remote sites.

In another aspect of the present invention, a system for sharing information relating to the status of a continuous process improvement project of a business operation between a plurality of remote sites and a central location is provided. This system includes a central computer at the central location for storing a form. This system further includes a remote computer at each of the plurality of remote sites for accessing the form from the central computer and relaying project information input into the form by an input user at one of the plurality of remote sites to the central computer. The central computer is adapted to collect, store and relay the project information to the remote computer at each of the plurality of remote sites.

### BRIEF DESCRIPTION OF THE DRAWINGS

FIG. 1 is a block diagram illustrating a system for sharing information relating to the status of a continuous process improvement project of a business operation between a plurality of remote sites;

FIG. 2 is a flow diagram illustrating a method for sharing information relating to the status of a continuous process improvement project of a business operation between a plurality of remote sites;

FIG. 3 is a diagram illustration of an input user operating at a remote site using a graphical user interface, according to an embodiment of the present invention;

FIG. 4 is a diagrammatic illustration of a Login Page Screen, according to an embodiment of the present invention;

FIG. 5 is a diagrammatic illustration of a Home Page Screen, according to an embodiment of the present invention;

FIG. 6 is a diagrammatic illustration of a Home Page Menu on the screen of FIG. 5, according to an embodiment of the present invention;

FIG. 7 is a diagrammatic illustration of a Process Improvement Screen, according to an embodiment of the present invention;

FIG. 8 is a diagrammatic illustration of a Process Improvement Menu on the screen of FIG. 7, according to an embodiment of the present invention;

FIG. 9 is a diagrammatic illustration of a Project Registration Screen, according to an embodiment of the present invention;

FIG. 10 is a diagrammatic illustration of an Administrator Report Screen, according to an embodiment of the present invention;

FIG. 11 is a diagrammatic illustration of a Project Reporting Menu on the screen of FIG. 10, according to an embodiment of the present invention;

FIG. 12 is a diagrammatic illustration of a Manage Dealer Project Screen, according to an embodiment of the present invention

FIG. 13 is a diagrammatic illustration of a Manage Dealer Project Menu on the screen of FIG. 12, according to an embodiment of the present invention;

FIG. 14 is a diagrammatic illustration of a Dealer Project Report Screen, according to an embodiment of the present invention;

FIG. 15A is a diagrammatic illustration of a Situation Assessment Text Box on the screen of FIG. 14, according to an embodiment of the present invention;

FIG. 15B is a diagrammatic illustration of a Gap Analysis Tool Screen, according to an embodiment of the present invention;

FIG. 15C is a diagrammatic illustration of a First Process Map Tool Screen, according to an embodiment of the present invention;

FIG. 15D is a diagrammatic illustration of a Statement Worksheet Tool Screen, according to an embodiment of the present invention;

FIG. 15E is a diagrammatic illustration of a Data Decision Worksheet Tool Screen, according to an embodiment of the present invention;

FIG. 15F is a diagrammatic illustration of an Involvement Worksheet Tool Screen, according to an embodiment of the present invention;

FIG. 16A is a diagrammatic illustration of a Determine Causes Text Box on the screen of FIG. 14, according to an embodiment of the present invention; FIG. 16B is a diagrammatic illustration of a Cause And Effect Tool Screen, according to an embodiment of the present invention;

FIG. 16C is a diagrammatic illustration of a Pareto Chart Tool Screen, according to an embodiment of the present invention;

FIG. 17A is a diagrammatic illustration of a Target Solutions Text Box on the screen of FIG. 14, according to an embodiment of the present invention;

FIG. 17B is a diagrammatic illustration of a Redefine Worksheet Tool Screen, according to an embodiment of the present invention;

FIG. 17C is a diagrammatic illustration of an Impact and Effort Table Tool Screen, according to an embodiment of the present invention;

FIG. 17D is a diagrammatic illustration of an Impact and Effort Grid Tool Screen, according to an embodiment of the present invention;

FIG. 17E is a diagrammatic illustration of an Solution and Impact Tool Screen, according to an embodiment of the present invention;

FIG. 17F is a diagrammatic illustration of a Second Process Map Tool Screen, according to an embodiment of the present invention;

FIG. 17G is a diagrammatic illustration of a Balance Sheet Tool Screen, according to an embodiment of the present invention;

FIG. 17H is a diagrammatic illustration of a Weighted Voting Tool Screen, according to an embodiment of the present invention;

FIG. 17I is a diagrammatic illustration of a Criteria Screen Tool Screen, according to an embodiment of the present invention;

FIG. 18A is a diagrammatic illustration of an Implementation Text Box on the screen of FIG. 14, according to an embodiment of the present invention;

FIG. 18B is a diagrammatic illustration of an Action Plan Tool Screen, according to an embodiment of the present invention;

FIG. 19A is a diagrammatic illustration of a Continuous Improvement Text Box on the screen of FIG. 14, according to an embodiment of the present invention;

FIG. 19B is a diagrammatic illustration of a Run Chart Tool Screen, according to an embodiment of the present invention;

FIG. 20 is a diagrammatic illustration of an Attachments Text Box on the screen of FIG. 14, according to an embodiment of the present invention;

FIG. 21 is a diagrammatic illustration of a Save As Screen, according to an embodiment of the present invention;

FIG. 22 is a diagrammatic illustration of an Executive Summary Screen, according to an embodiment of the present invention;

FIG. 23 is a diagrammatic illustration of an Executive Summary Text Box on the screen of FIG. 22, according to an embodiment of the present invention;

FIG. 24 is a diagrammatic illustration of an Executive Summary Results Text Box on the screen of FIG. 22, according to an embodiment of the present invention;

FIG. 25 is a diagrammatic illustration of a Best Practices Projects Screen, according to an embodiment of the present invention;

FIG. 26A is a diagrammatic illustration of a Consolidated Process Overview Table on the screen of FIG. 25, according to an embodiment of the present invention;

FIG. 26B is a diagrammatic illustration of Project Link Action Keys on the table of FIG. 26A, according to an embodiment of the present invention;

FIG. 29 is a diagrammatic illustration of a Search Best Practices Screen, according to an embodiment of the present invention;

FIG. 30 is a diagrammatic illustration of a Search Results Screen, according to an embodiment of the present invention;

FIG. 31 is a diagrammatic illustration of a Team Members Screen, according to an embodiment of the present invention;

FIG. 32A is a diagrammatic illustration of a Manage Best Practice Projects Screen, according to an embodiment of the present invention;

FIG. 32B is a diagrammatic illustration of a Manage Best Practice Projects Menu on the screen of FIG. 32A, according to an embodiment of the present invention;

FIG. 33 is a diagrammatic illustration of a Change Year Screen, according to an embodiment of the present invention;

FIG. 34 is a diagrammatic illustration of an Add New Project Screen, according to an embodiment of the present invention;

FIG. 35 is a diagrammatic illustration of a Manage Administrators Screen, according to an embodiment of the present invention;

FIG. 36 is a diagrammatic illustration of an Edit Project Attributes Screen, according to an embodiment of the present invention;

FIG. 37 is a diagrammatic illustration of a Delete Project Screen, according to an embodiment of the present invention;

FIG. 38 is a diagrammatic illustration of an Add Dealer Project Screen, according to an embodiment of the present invention;

FIG. 39 is a diagrammatic illustration of an Edit Consolidated Process Overview Screen, according to an embodiment of the present invention;

FIG. 40 is a diagrammatic illustration of an Edit Dealer Attributes Screen, according to an embodiment of the present invention; and

FIG. 41 is a diagrammatic illustration of a Delete Dealer Project Screen, according to an embodiment of the present invention.

### DETAILED DESCRIPTION

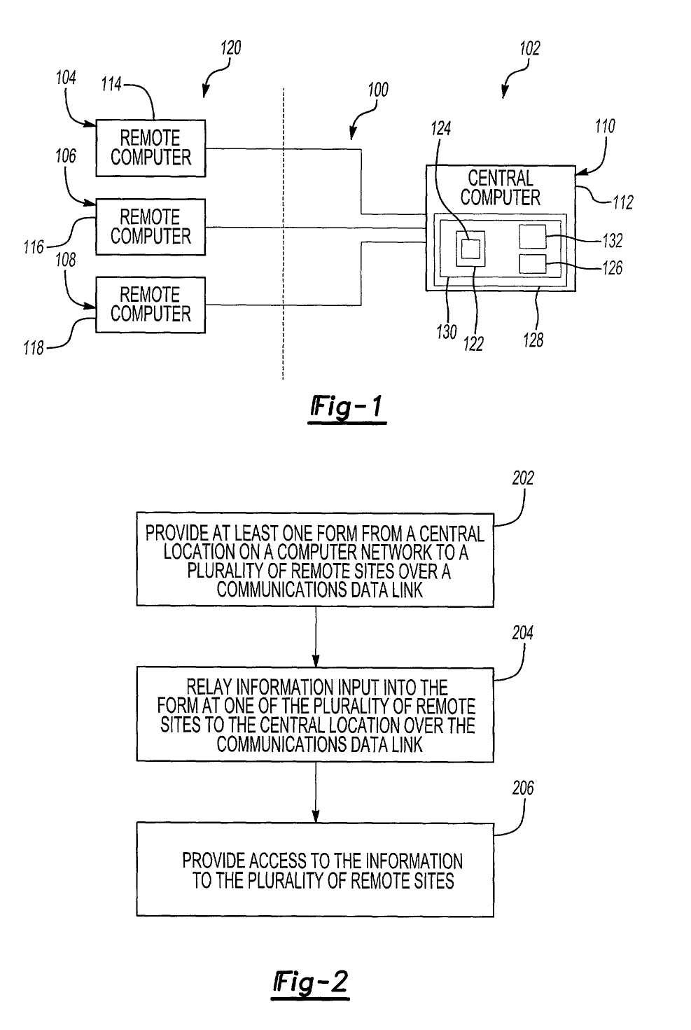

With reference to the drawings and in operation, the present invention relates to a system 102 and method for sharing information relating to the status of a continuous process improvement project 1450 of a business operation between a plurality of remote sites 104, 106, 108 and a central location 110. With reference to FIGS. 1, 2 and 3, a system for sharing information among three remote sites 104, 106, 108 is shown. However, the present system is applicable to systems with two remote sites or more than three remote sites. The remote sites 104, 106, 108 communicate with the central location 110 on a computer network 120 via a communications data link 100.

In the preferred embodiment, the data communications link 100 could be a satellite, a modem and a cable television network.

A central computer 112 at the central location 110 stores a form or forms which is accessible by the remote computer 114, 116, 118 at each of the plurality of remote sites 104, 106, 108 over the communications data link 100. The forms can be found on one or more computer screens, as described below. Project information input into the form by an input user 306 at one of the plurality of remote sites 104, 106, 108 is relayed to the central computer 112 over the communications data link 100. The central computer 112 is adapted to collect, store and relay the project information to the remote computer 114, 116, 118 at each of the plurality of remote sites 104, 106, 108 over the communications data link 100.

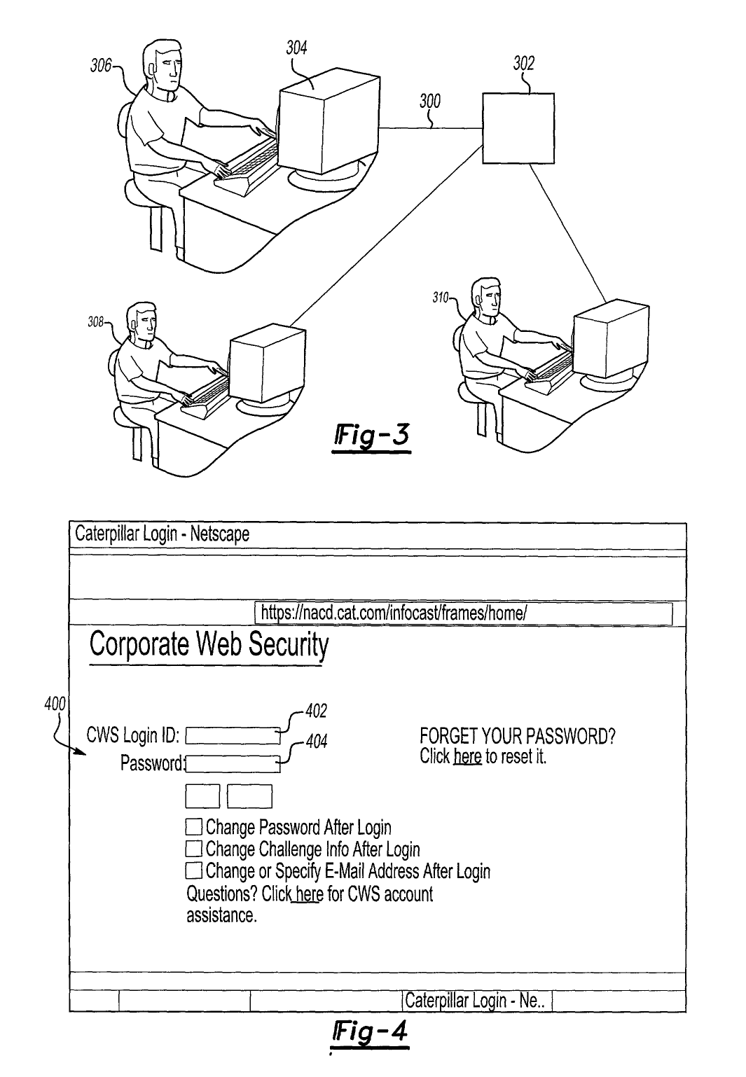

With reference to FIG. 2, a method for sharing information relating to the status of a continuous process improvement project 1450 of a business operation between a plurality of remote sites 104, 106, 108 and a central location 110 is provided. In a first control block 202, at least one form is provided to a plurality of remote sites 104, 106, 108 over the communications data link 100 from a central location 110 on a computer network 120. In a second control block 204, the information input into the form at one of the plurality of remote sites 104, 106, 108 is relayed to the central location 110 over the communications data link 100. In a third control block 206, access to the information is provided to the plurality of remote sites 104, 106, 108.

In one embodiment, the method and system of the present invention may be used by a manufacturer and dealers. However, the present invention is equally applicable to other business environments involving information sharing among multiple remote sites. For example a company having distributed offices, or a business and their associated supplies, etc.

A dealer at the plurality of remote sites 104, 106, 108 creates a continuous improvement team to identify and address business processes to improve efficiencies and reduce costs of a business operation. The team measures performance to gauge the effectiveness of business processes, services, products and the overall organization and targets processes for improvement that will make a significant impact. The targeted processes become projects in which the team generates a report to capture the project identified and share project information. In particular, the project information shared consists of an opportunity for improvement identified, causes of the opportunity for improvement considered, solution alternatives evaluated, a selected solution implemented and steps taken for maintenance of the new process and monitoring results.

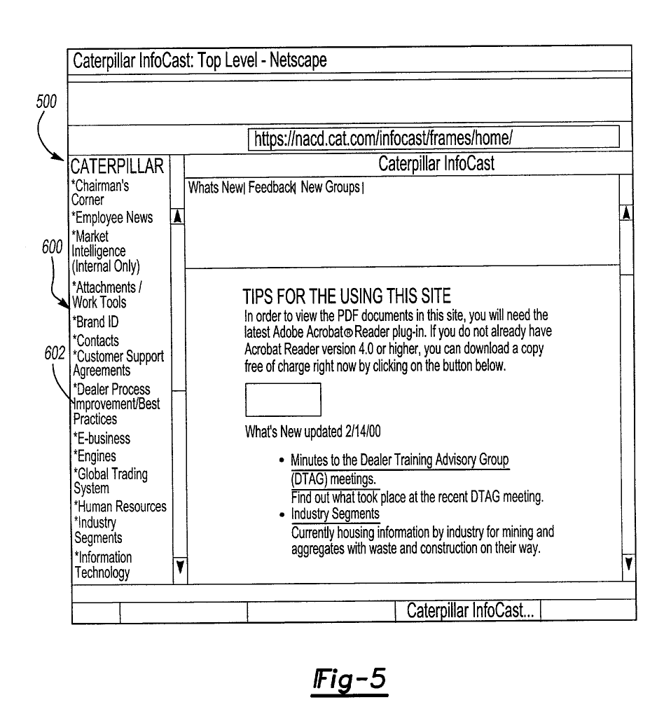

With specific reference to FIG. 3, the project information is entered into the form provided from the central location 110, wherein the central location 110 may have a web server 128 including a global directory server 130 wherein a database 122 resides having data tables 124 and an access control module 126. The dealer acquires access to the database 122 residing on a web site for project registration and accessing a form to input the project information. The dealer then relays the project information to the central location 110. An administrator residing at the central location 110 creates a form for the continuous process improvement project report. A dealer facilitator having access rights to the form then enters the project registation information into the form residing at the central location 110. Upon completing information entry, the dealer facilitator submits the information to the central location 110, and the project information is available for sharing with the plurality of remote sites 104, 106, 108. A start date is assigned to the project. The start date assiged is the date on which the administrator created the form for the continuous process improvement project. A modification date is assigned each time the project information is modified.

Subsequently, throughout the course of the project, a team member updates the project report from a remote site 104, 106, 108, i.e., a dealer, with project information. At the conclusion of the project, a team member creates an executive summary from an executive summary form accessed from the remote site 104, 106, 108. Again, the project information is entered on the form in a condensed format and relayed to the central location 110. After the project report and executive summary are created, each can be accessed by access users 308, 310 at any of the plurality of remote locations 104, 106, 108 through a best practices database 132. The best practices database 132 is created and maintained by the administrator.

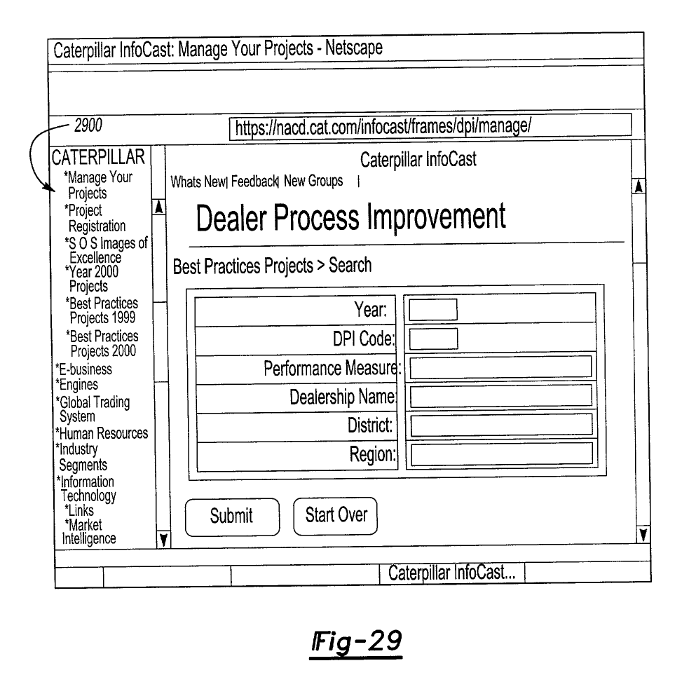

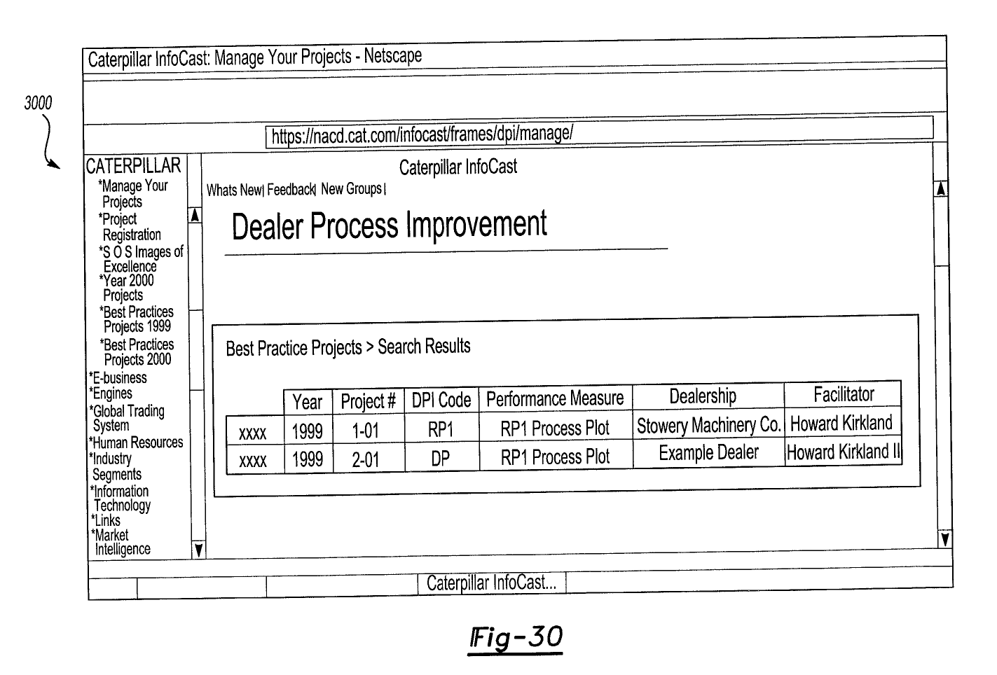

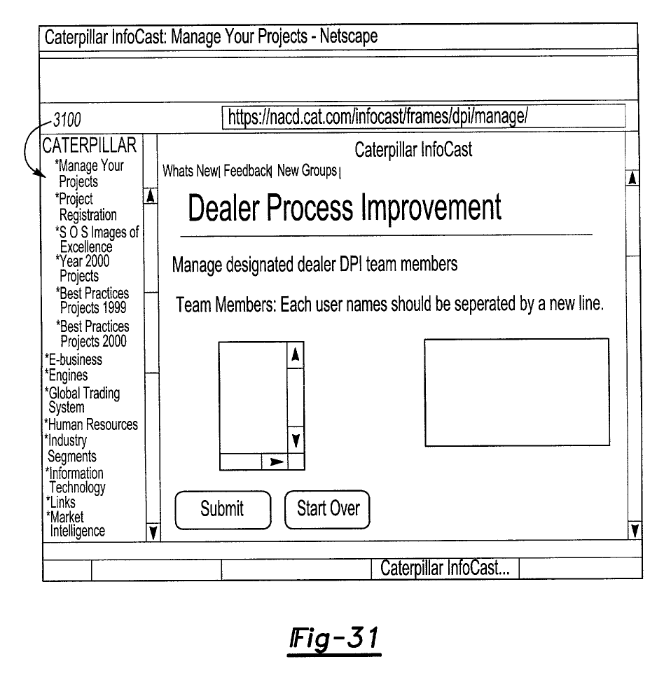

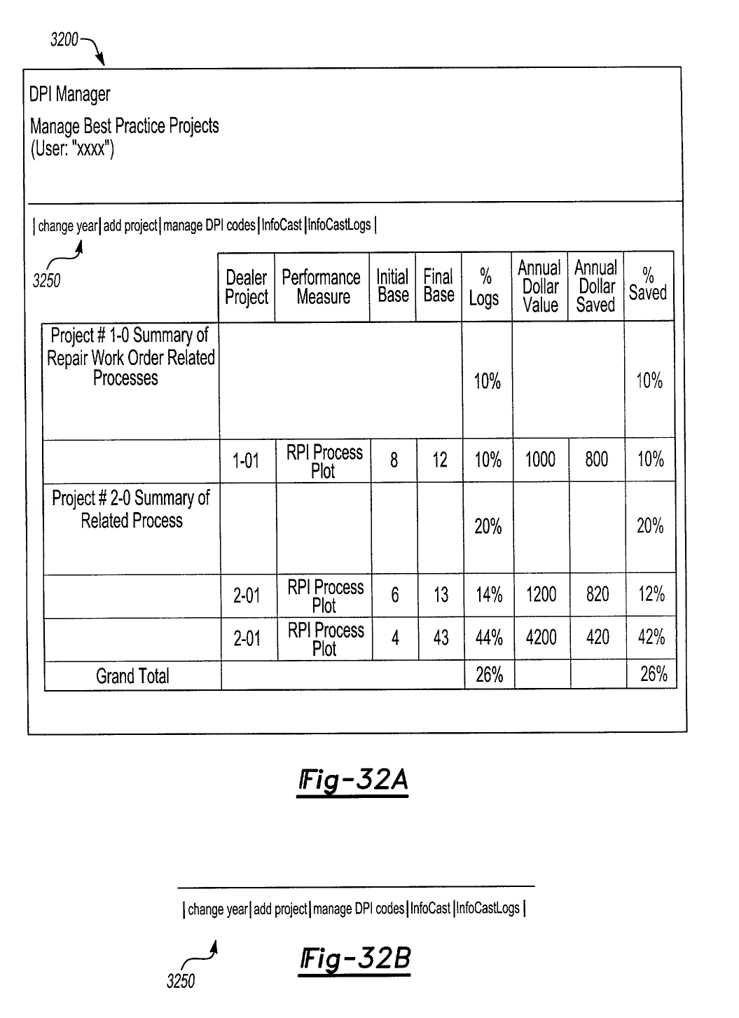

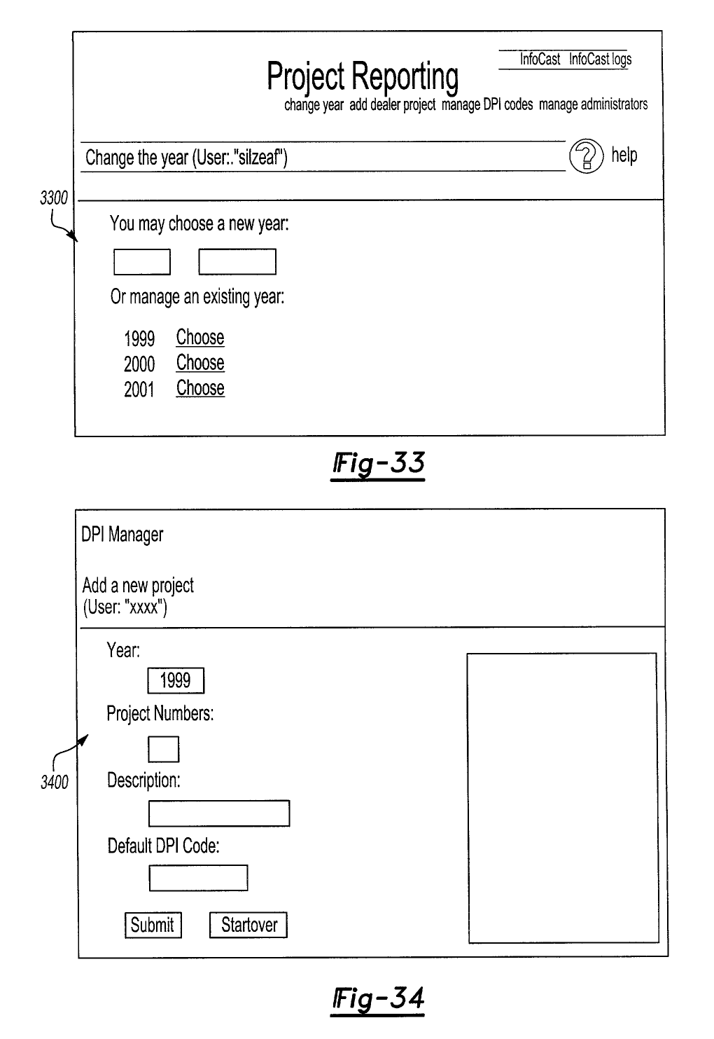

Administrators have almost exclusive access to various screens for manipulating a database 122. For instance, a Team Members Screen 3100, as shown in FIG. 31 allows an administrator and a facilitator to manage a dealer project's team. With reference to FIG. 32, a Manage Best Practice Projects Screen 3200 allows an administrator to create an administrator report and manipulate projects and databases by selecting a desired project element as shown in a Manage Best Practice Projects Menu 3250. As shown in FIG. 33, A Change Year Screen 3300 allows an administrator to manage years for best practice databases 132 and project reports. With reference to FIG. 34, an Add New Project Screen 3400 allows an administrator to add new projects. A Manage Administrators Screen 3500 allows administrators to manage administrators and includes a list of current users assigned to an administrator and contact information for each assigned user.

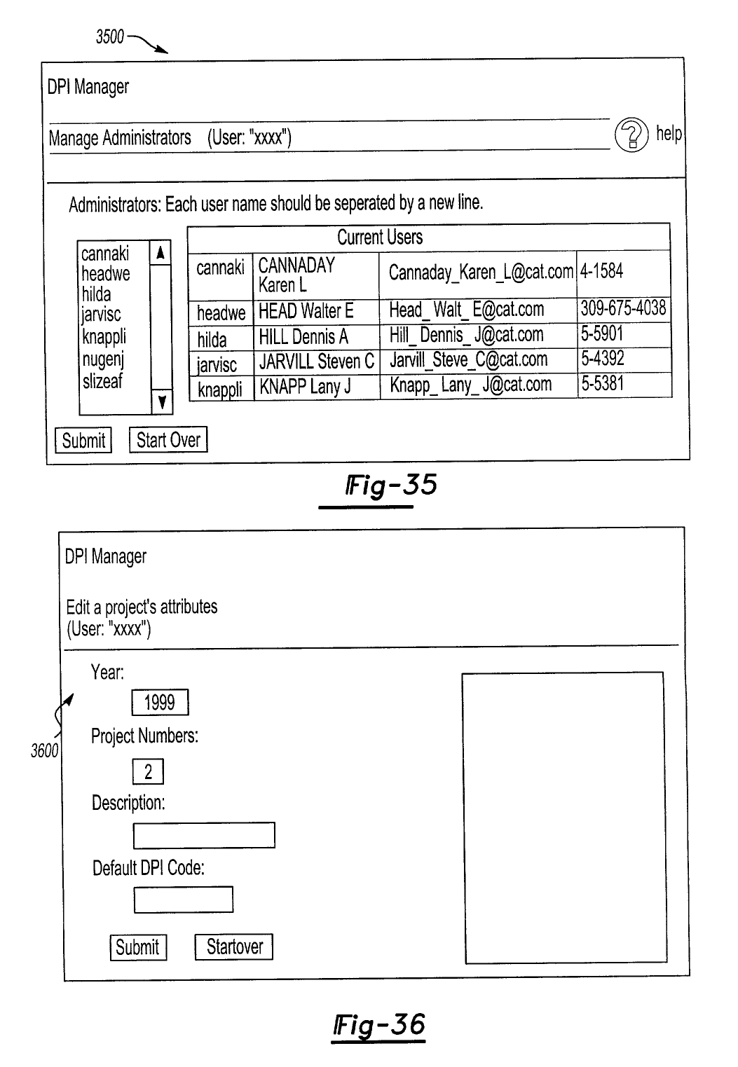

Exclusive administrator access screens further include an Edit Project Attributes Screen 3600 for allowing administrators to edit attributes of an existing continuous process improvement project 1450, as shown in FIG. 36.

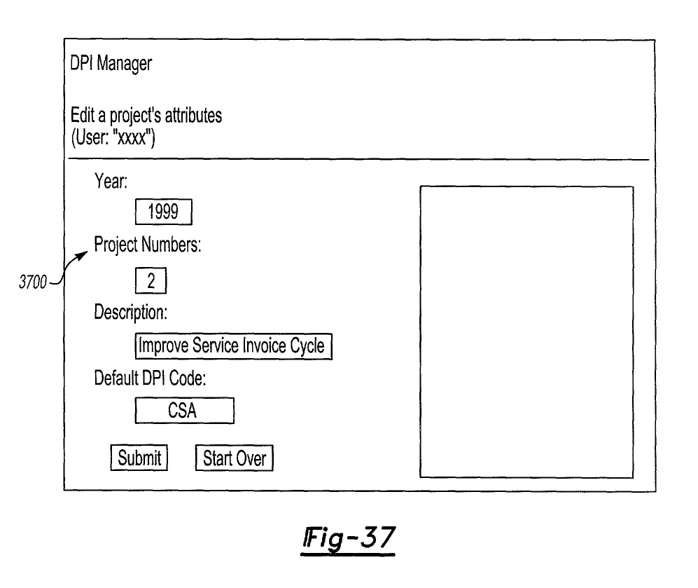

With reference to FIG. 37, a Delete Project Screen 3700 allows an administrator to delete an existing continuous process improvement project 1450.

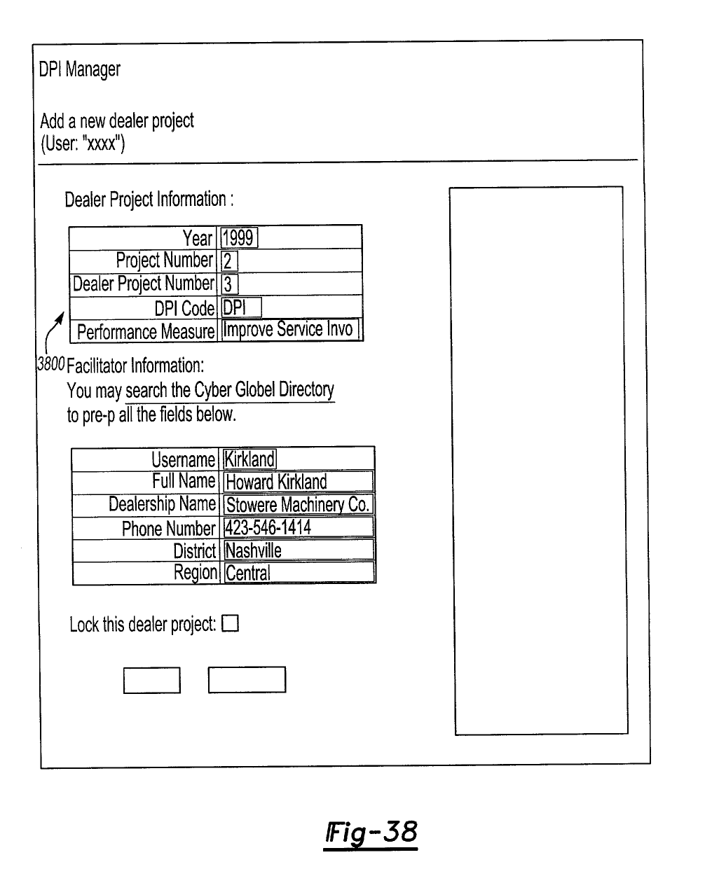

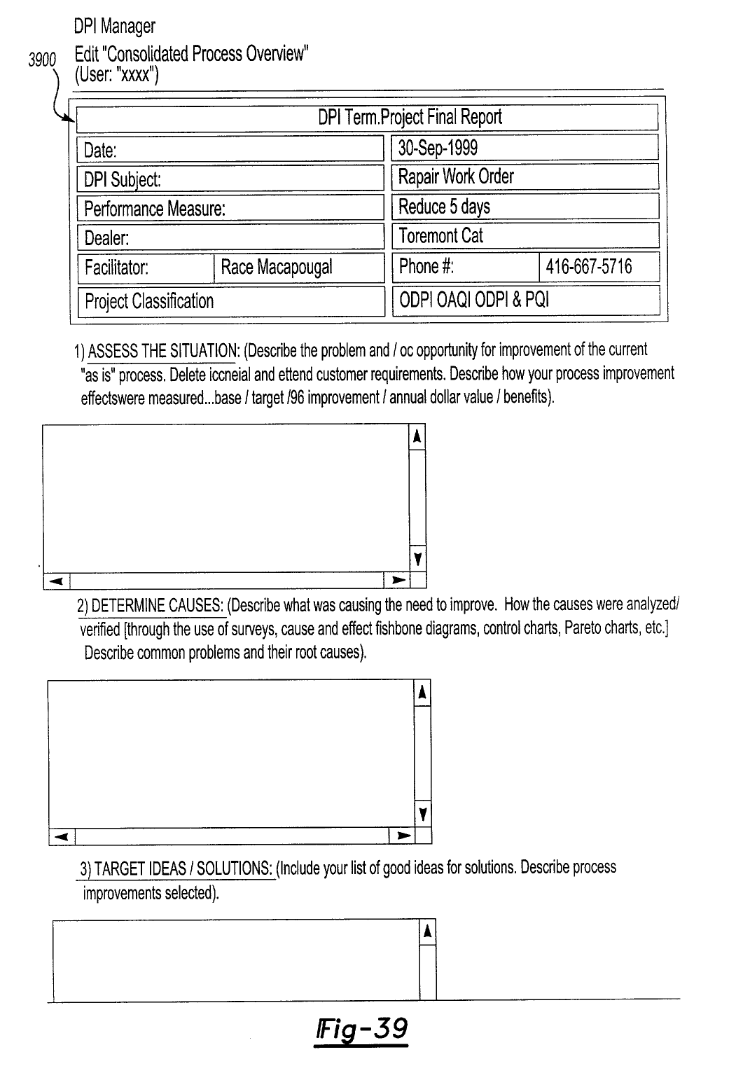

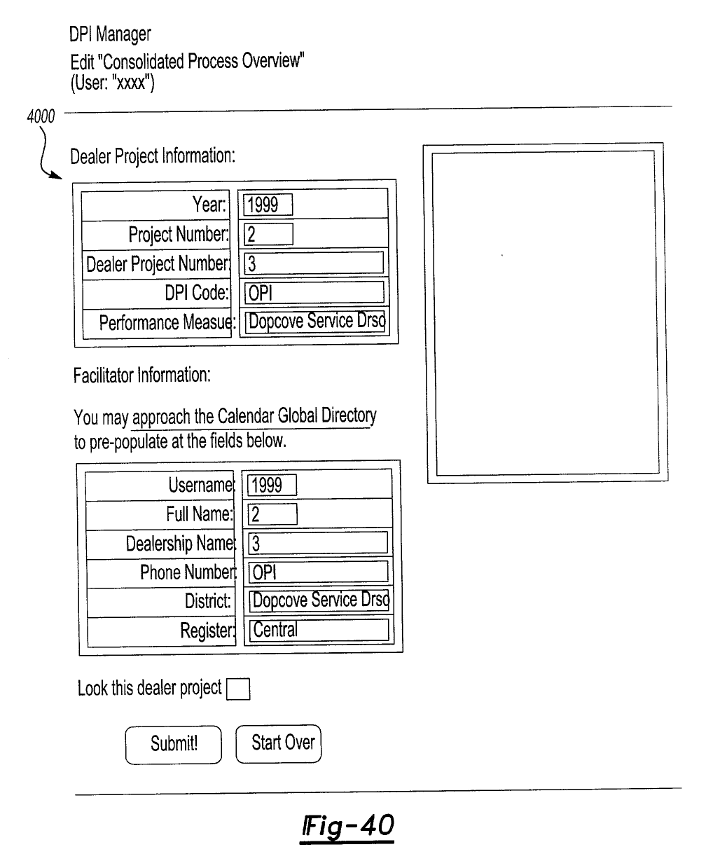

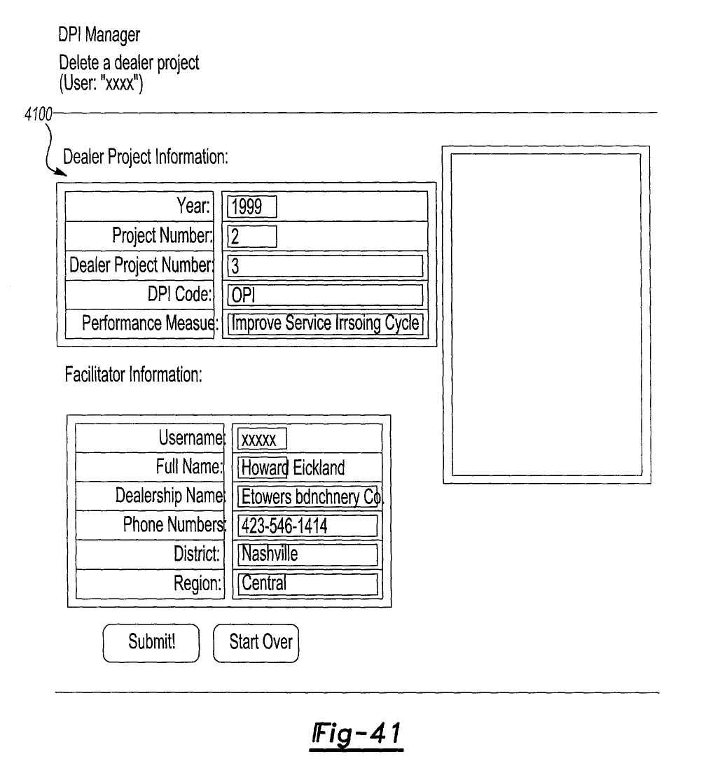

With reference to FIG. 38, an Add Dealer Project Screen 3800 allows an administrator to add new continuous process improvement projects 1450. With reference to FIG. 39, an Edit Consolidated Process Overview Screen 3900 allows an administrator to manage a consolidated process overview of the continuous process improvement project 1450. As shown in FIG. 40, an Edit Dealer Attributes Screen 4000 allows an administrator to edit attributes of an existing dealer project. With reference to FIG. 41, a Delete Dealer Project Screen 4100 allows an administrator to delete an existing dealer project.

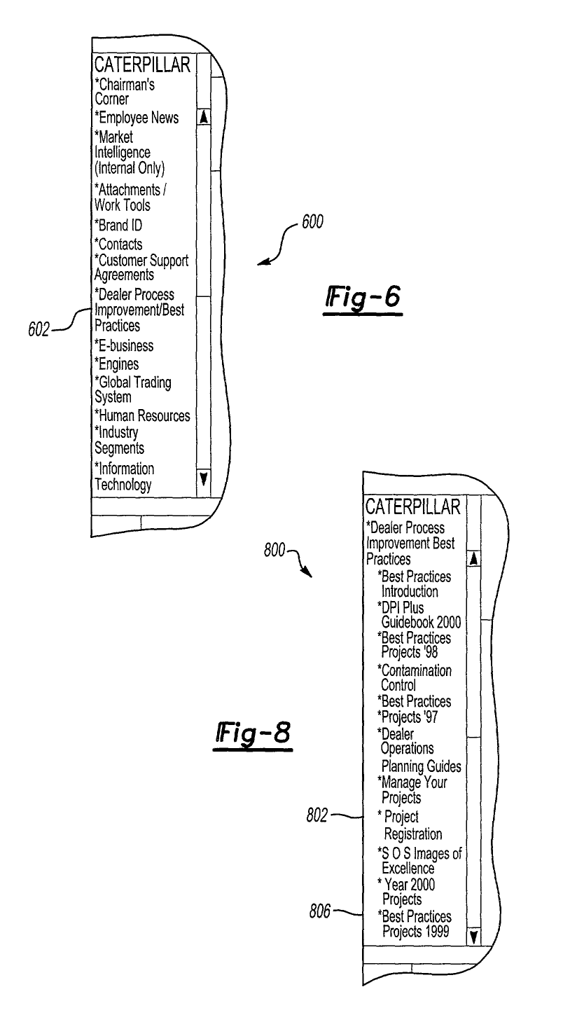

For the purposes of this invention, the information shared is project information relating to a continuous process improvement project 1450. With reference to FIGS. 4-30, the present invention provides a graphical user interface 304 for use by an input user 306 and an access user 308, 310 to interface with the system 102.

With reference to FIG. 4, the graphical user interface 304 includes a Login Screen 400 including a Login Id Text Box 402 and a Password Text Box 404 for the input user 306 and access user 308, 310 to gain access to a database 122 of forms and project information in the system 102.

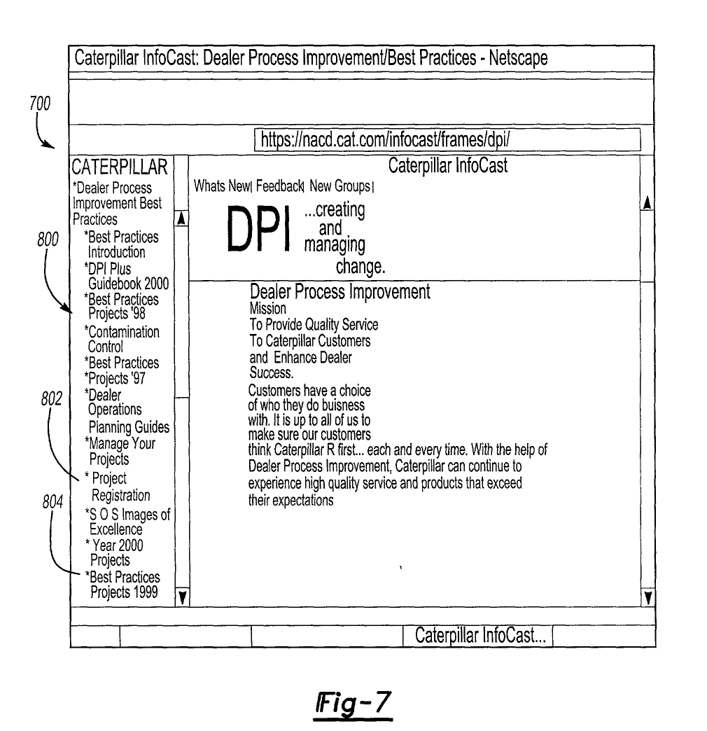

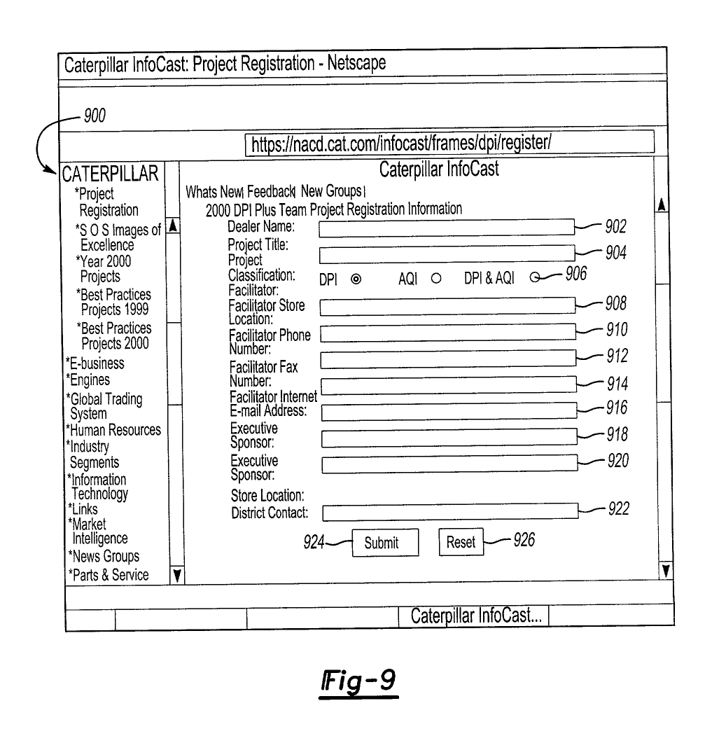

With reference to FIG. 5, after performing a successful login into the system 102, the graphical user interface 304 displays a Home Page Screen 500. The Home Page Screen 500 includes a Home Page Menu 600, as shown in FIG. 6, where the input user 306 and access users 308, 310 select a Dealer Process Improvement/Best Practices Button 602 from the Home Page Menu 600 to navigate to a Process Improvement Screen 700.

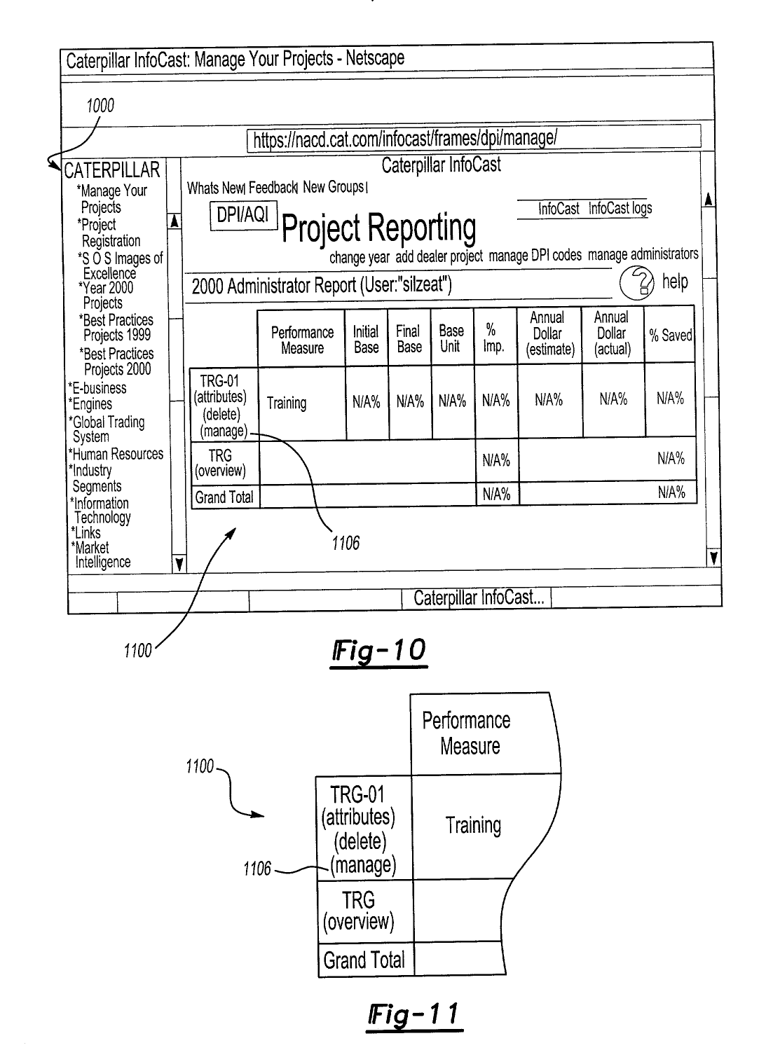

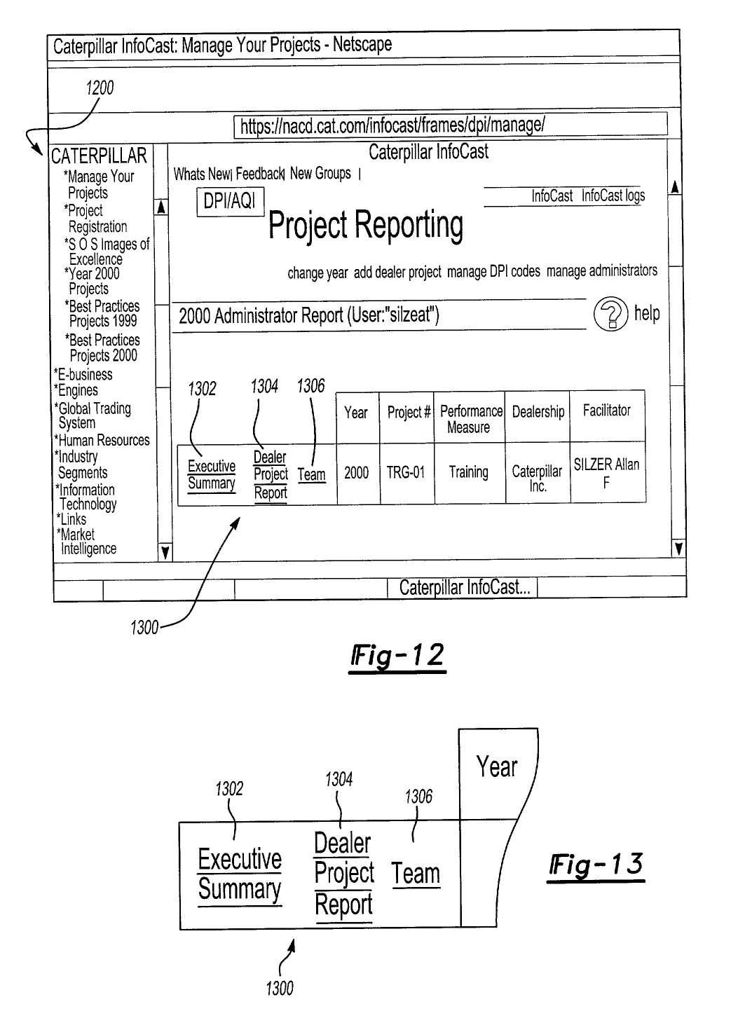

With reference to FIGS. 7 and 8, the Dealer Process Improvement Screen 700 includes a Process Improvement Menu 800, as shown in FIG. 8. From the Process Improvement Menu 800, the input user 306 selects a Project Registration Item 802 to register a new project.

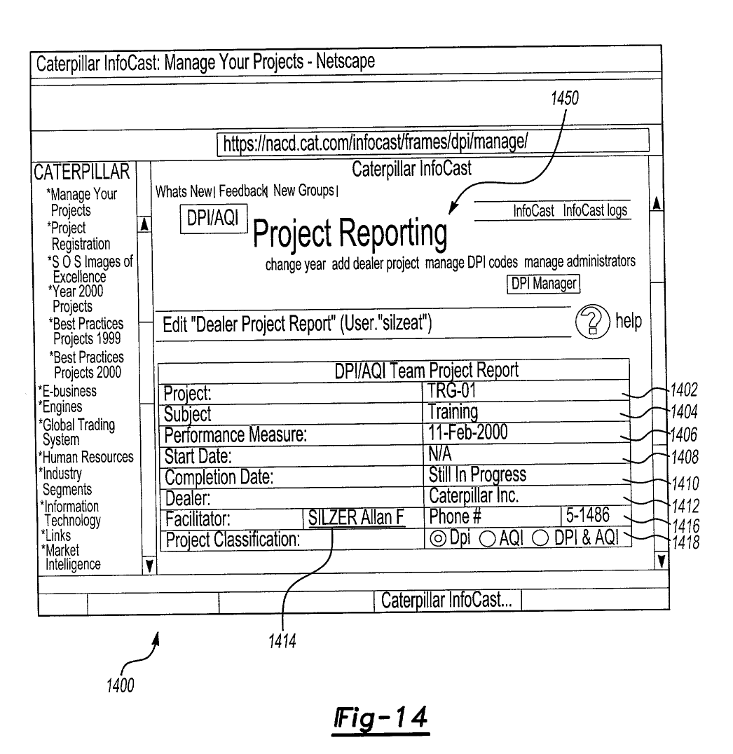

With reference to FIG. 9, the new project is registered on the Project Registration Screen 900. In particular, the Project Registration Screen 900, for inputting information by the input user 306 to register a project, includes a Dealer Name Text Box 902, a Project Title Text Box 904 and a Project Classification Text Box 906. The Project Registration Screen 900 further includes a Facilitator Text Box 908, a Facilitator Store Location Text Box 910, a Facilitator Phone Number Text Box 912, a Facilitator Fax Number Text Box 914 and Facilitator Internet E-mail Address Text Box 916. In addition, the Project Registration Screen 900 includes an Executive Sponsor Text Box 918, an Executive Sponsor Store Location Text Box 920 and a District Contact Text Box 922.

After the information is input, the input user 306 selects a Submit Button 924, to relay the information from the remote location 104, 106, 108 to the central location 110, or a Reset Button 926 to clear the text boxes 902, 904, 906, 908, 910, 912, 914, 916, 918, 920, 922 on the screen 900 and enter information for another project. Upon receipt of the information at the central location 110, an administrator creates a dealer project report containing the information for project identification and enables the input user 306 to input additional project information.

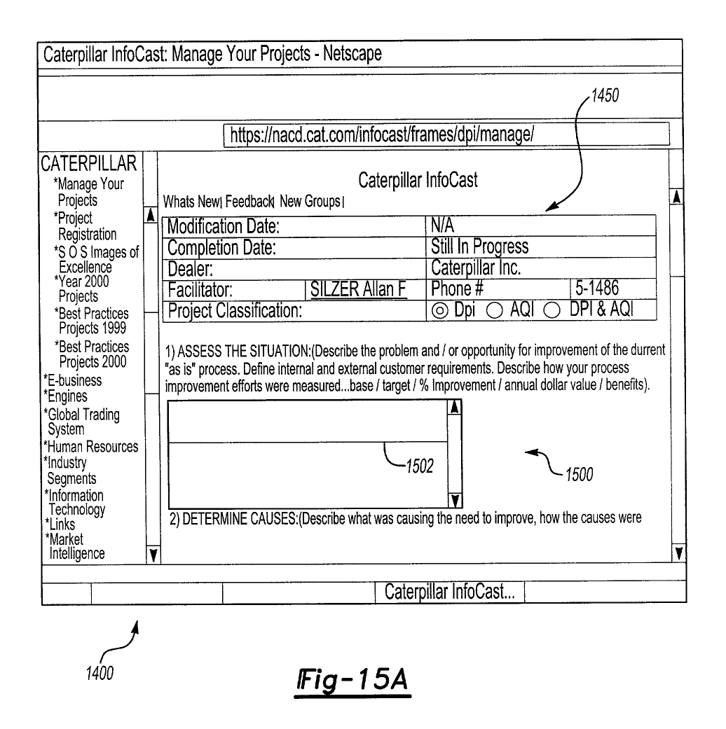

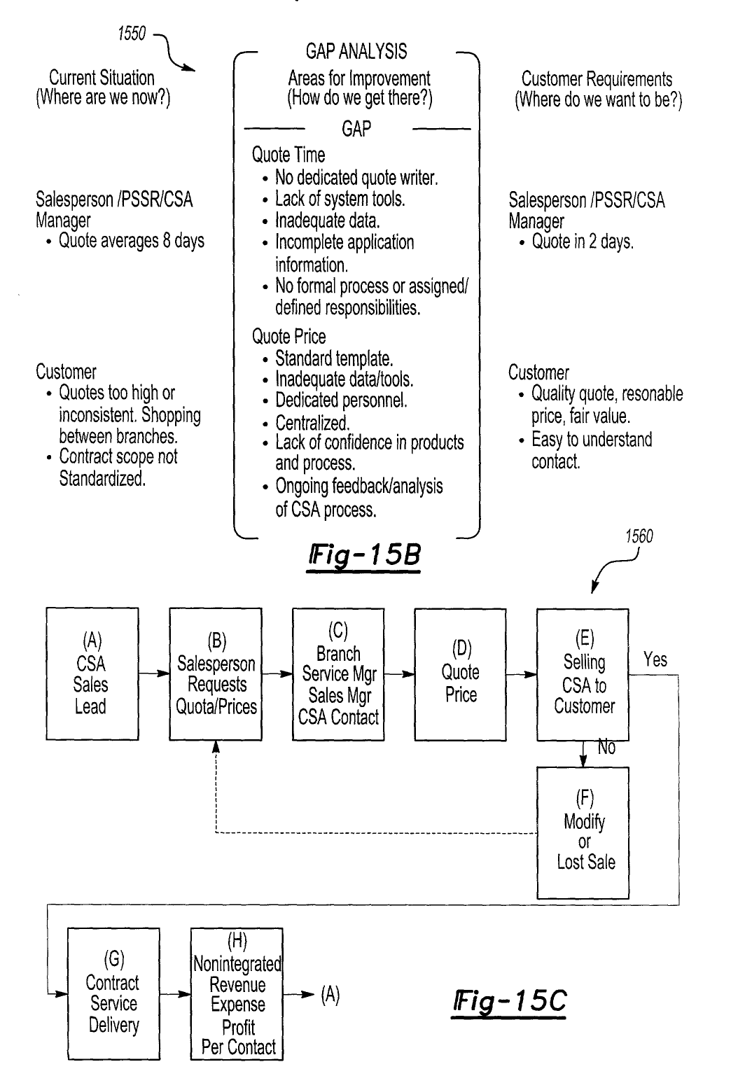

With reference to FIGS. 10 and 11, following submission of the project registration information, an Administrator Report Screen 1000 is displayed, which includes a Project Reporting Menu 1100.

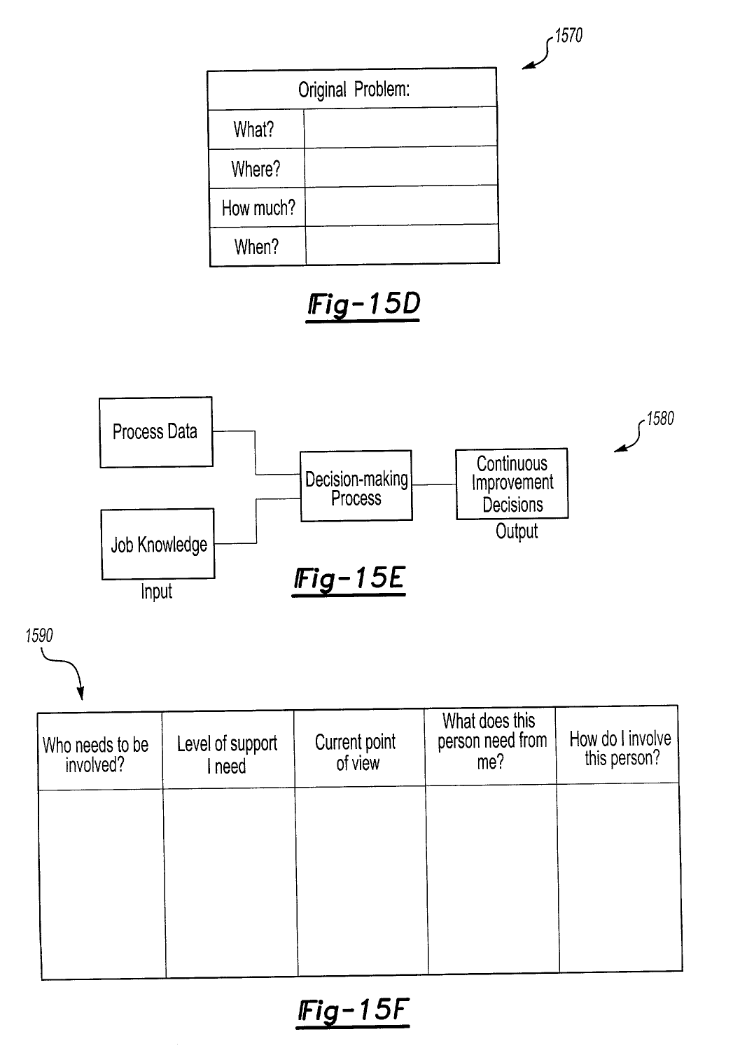

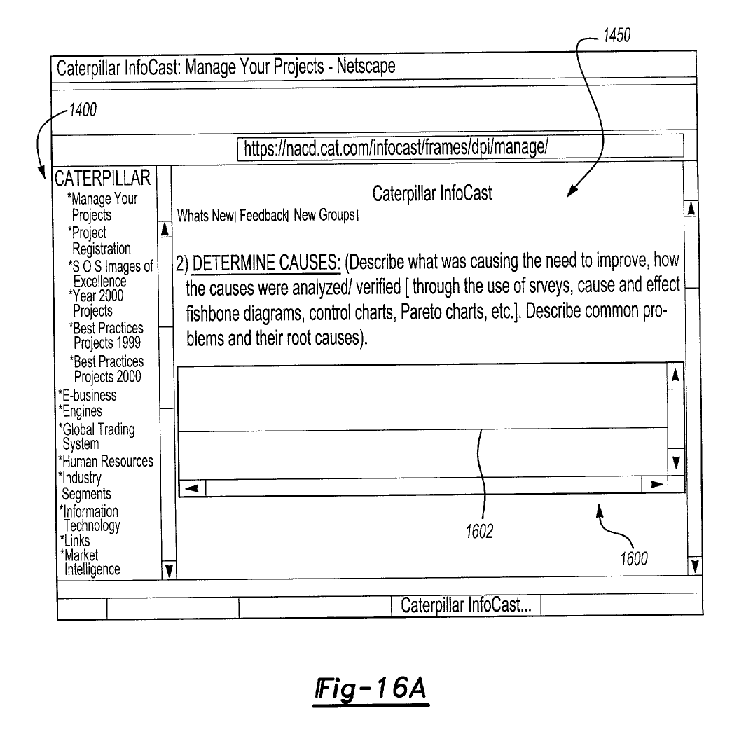

With reference to FIGS. 12 and 13, the input user 306 selects the Manage Item 1106 from the Project Reporting Menu 1100 to display a Manage Dealer Project Screen 1200 having a Manage Dealer Project Menu 1300. The Manage Dealer Project Menu 1300 includes an Executive Summary Item 1302, a Dealer Project Report Item 1304 and a Team Item 1306 for entering team members involved in the project.

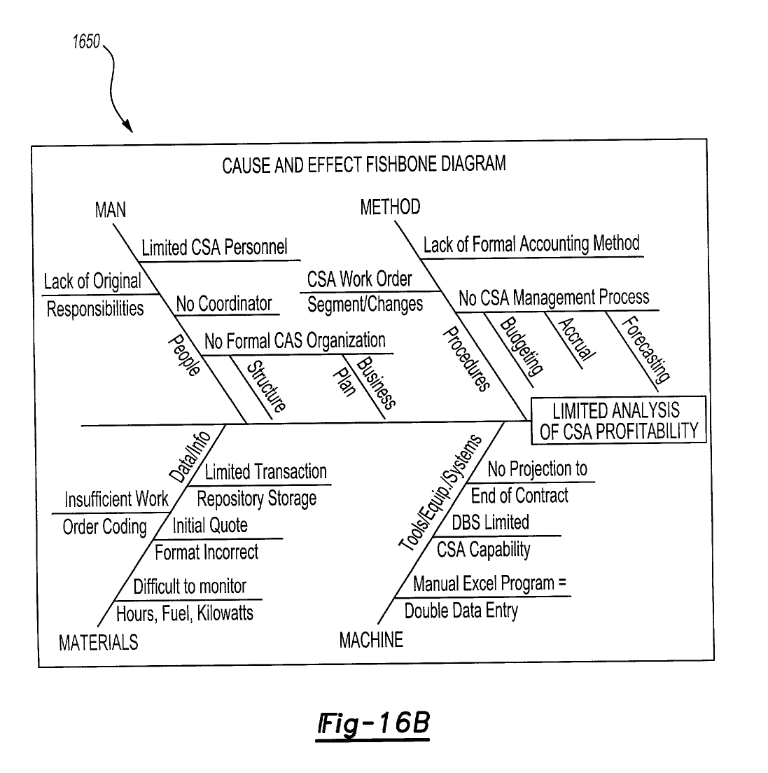

With reference to FIG. 14, selecting the Dealer Project Report Item 1304 displays a Dealer Project Report Screen 1400 containing the information entered on the Project Registration Screen 900 and manipulated by the administrator.

The information manipulated into project information by the administrator includes at least one Project Identifier Data Field 1402, Project Description Data Field 1404 and a Project Classification Data Field 1418. The project information further includes a Start Date Data Field 1406, a Modification Date Data Field 1408 and a Completion Date Data Field 1410. In addition, the project information includes a Dealer Name Data Field 1412, a Facilitator Name Data Field 1414 and a Facilitator Contact Data Field 1416 for providing means for communicating with a facilitator.

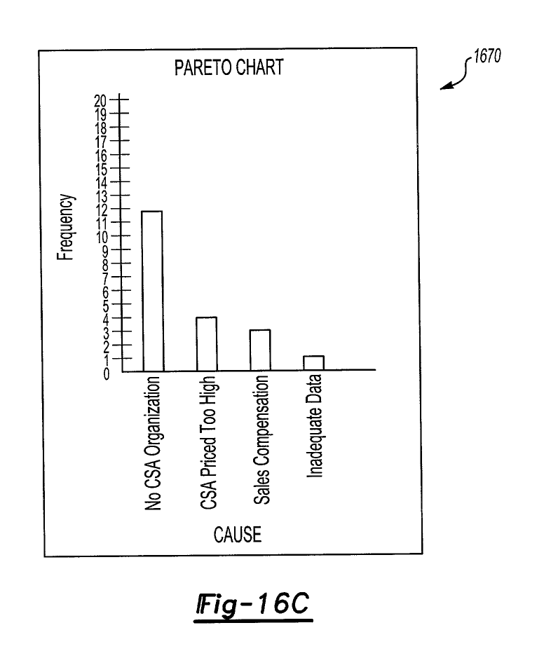

With reference to FIG. 15A, the Dealer Project Report Screen 1400 further includes a Situation Assessment Text Box 1500 having situation assessment information 1502. The situation assessment information 1502 may be input by an input user 306 or viewed by an access user 308, 310. The situation assessment information 1502 describes a problem or an opportunity for improvement of a current process, customer requirements and measurement techniques of improvement efforts. The situation assessment information 1502 includes a first problem description, a first improvement opportunity description, a current process description, a customer requirement description and a measurement description relating to measuring improvement resulting from the continuous process improvement project 1450.

Several analysis tools may be used throughout the continuous process improvement project for determining project information. Moreover, these analysis tools may be provided in forms from the central location 110 and viewed on screens at the plurality of remote sites 104, 106, 108. For example, with reference to FIGS. 15B-F, several tools are available for defining an opportunity for improvement including a Gap Analysis Tool, a Process Map Tool, a Statement Worksheet Tool, a Decision Worksheet Tool and an Involvement Worksheet Tool. The graphic user interface 400 includes a Gap Analysis Tool Screen 1550, a First Process Map Tool Screen 1560, a Statement Worksheet Tool Screen 1570, a Decision Worksheet Tool Screen 1580 and an Involvement Worksheet Tool Screen 1590 for providing access to these tools, respectively.

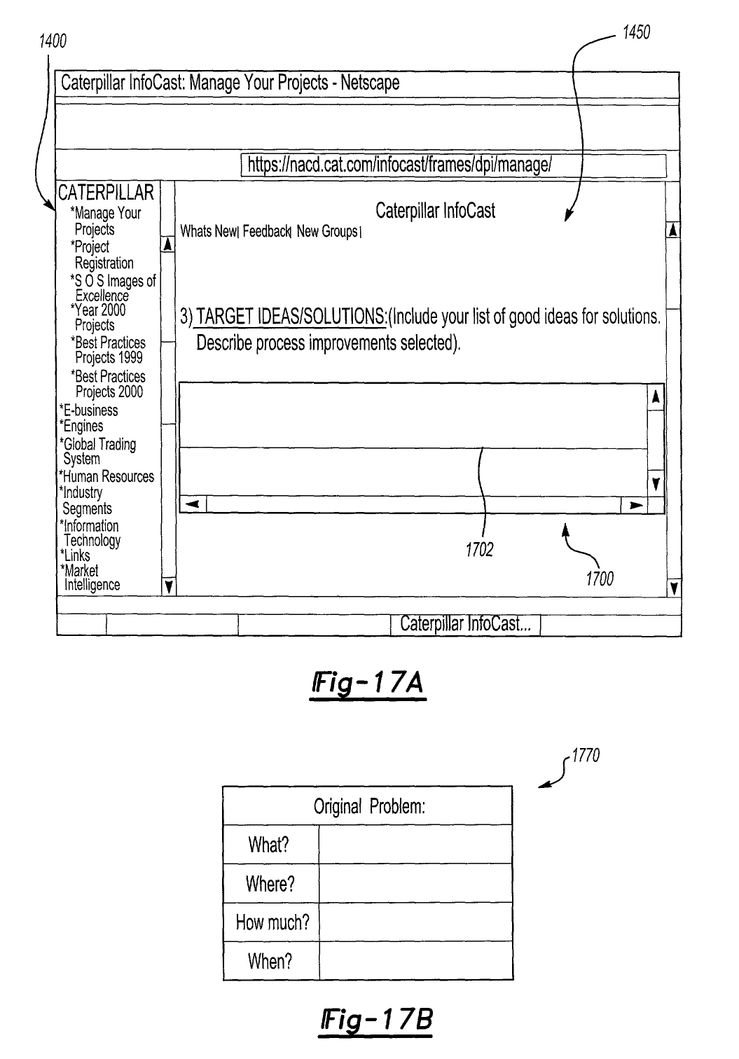

With reference to FIG. 16A, the Dealer Project Report Screen 1400 further includes a Determine Causes Text Box 1600 for causal information 1602 describing causes of the opportunity for improvement and cause analysis and verification. The causal information 1602 may be input by an input user 306 or viewed by an access user 308, 310. The causal information includes a cause identification description, a cause analysis description, a first cause verification description, at least one symptom description and at least one root cause description relating to each at least one symptom description.

With reference to FIGS. 16B-C, various tools are available for identifying, analyzing and verifying causes including a Cause and Effect Tool Screen 1650, a Pareto Chart Tool Screen 1670, an Impact and Effort Grid Tool Screen 1777, a Solution and Impact Tool Screen 1780 and an Involvement Worksheet Tool Screen 1590.

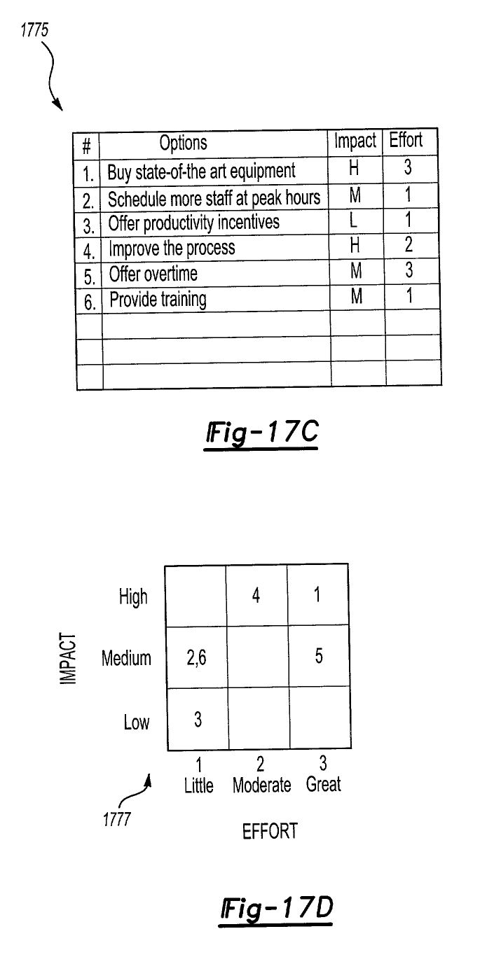

With reference to FIG. 17A, the Dealer Project Report Screen 1400 further includes a Target Solutions Text Box 1700 for solution information 1702 listing potential solutions and selected solutions for the opportunity for improvement, thereby resulting in a new process. The solution information 1702 may be input by an input user 306 or viewed by an access user 308,310. The solution information includes at least one potential solution description and a first selected solution description for creating an improved process.

With reference to FIGS. 17B-I, various tools are available for identifying and selecting solutions including a Redefine Worksheet Tool Screen 1770, an Impact and Effort Grid Tool Screen 1777, a Solution and Impact Tool Screen 1780, a Second Process Map Tool Screen 1785, a Balance Sheet Tool Screen 1790, a Weighted Voting Tool Screen 1795, a Criteria Screen Tool Screen 1797 and an Involvement Worksheet Tool Screen 1590.

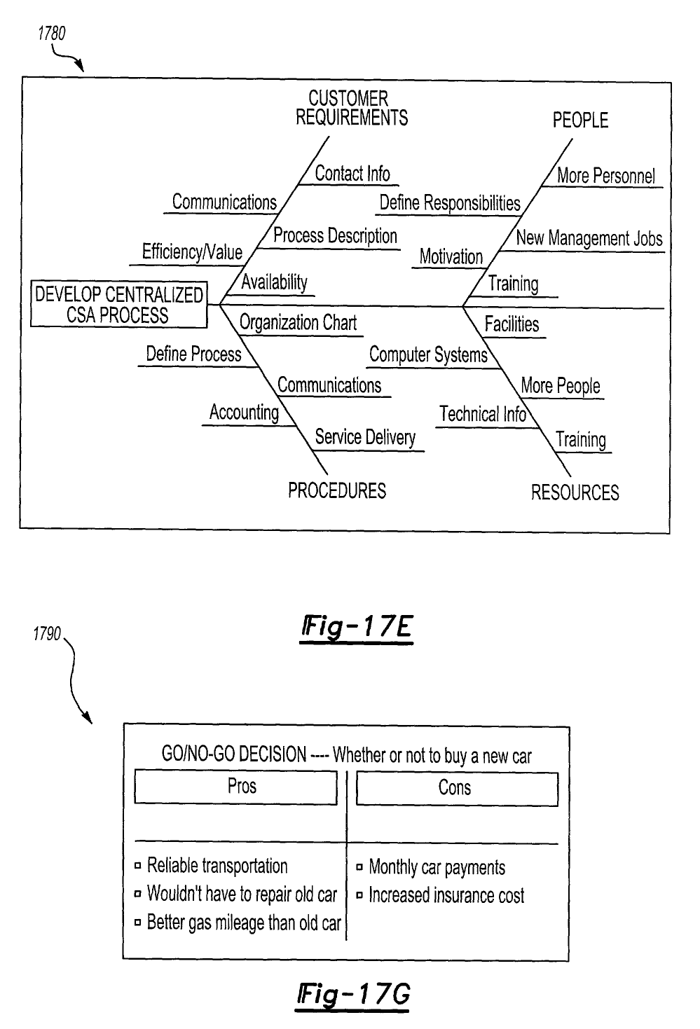

With reference to FIG. 18A, the Dealer Project Report Screen 1400 further includes an Implementation Text Box 1800 for solution implementation information 1802 describing how the new process was deployed and how the effectiveness of the new process was evaluated. The solution implementation information 1802 may be input by an input user 306 or viewed by an access user 308, 310. The solution implementation information includes a first solution deployment description and a first solution effectiveness description.

With reference to FIG. 18B, various tools are available for determining deployment and implementation plans including an Action Plan Tool Screen 1850, a First Process Map Tool Screen 1560 and an Involvement Worksheet Tool Screen 1590.

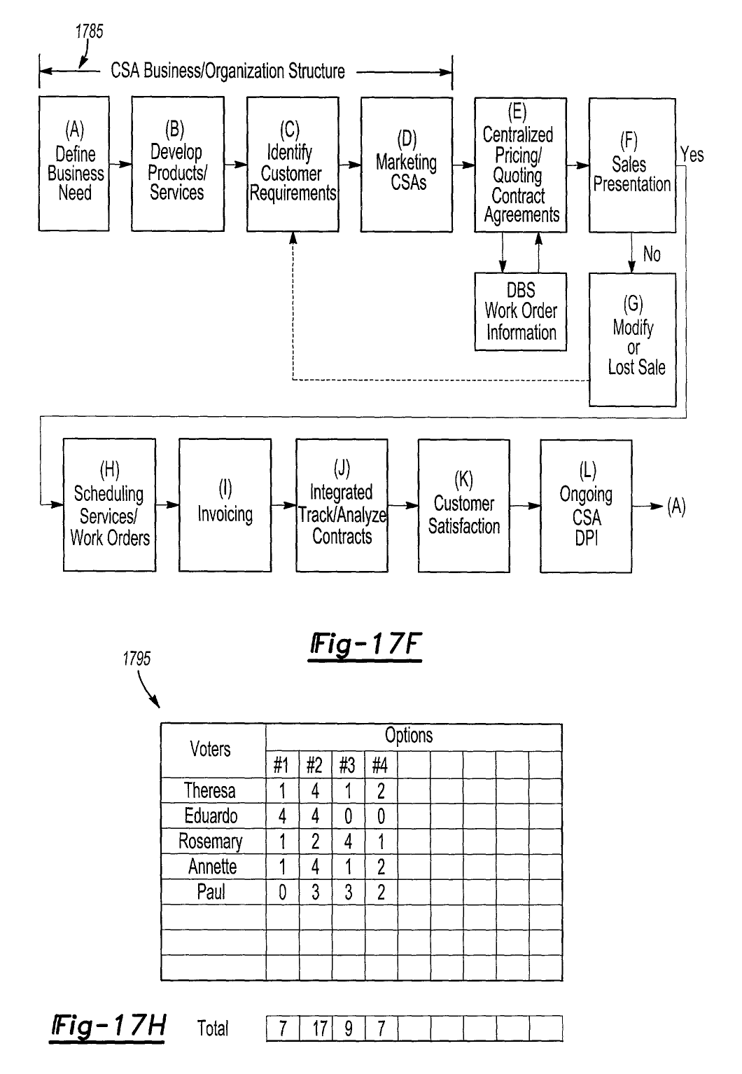

With reference to FIG. 19A, the Dealer Project Report Screen 1400 further includes a Continuous Improvement Text Box 1900 having continuous process improvement information 1902 for evaluating results of the new process. The continuous process improvement information 1902 may be input by an input user 306 or viewed by an access user 308, 310. The continuous process improvement information 1902 includes a comparison description relating to first former process results and first new process results, a value description relating to monetary value of the first new process results, a benefit description and a maintenance plan description. In addition, where more than one process result is used to track process improvement, the continuous process improvement information 1902 may include a summary comparison description relating to second former process results and second new process results.

With reference to FIG. 19B, various tools are available for evaluating results of the new process including a Run Chart Tool Screen 1950, Gap Analysis Tool Screen 1550 and an Involvement Worksheet Tool Screen 1590.

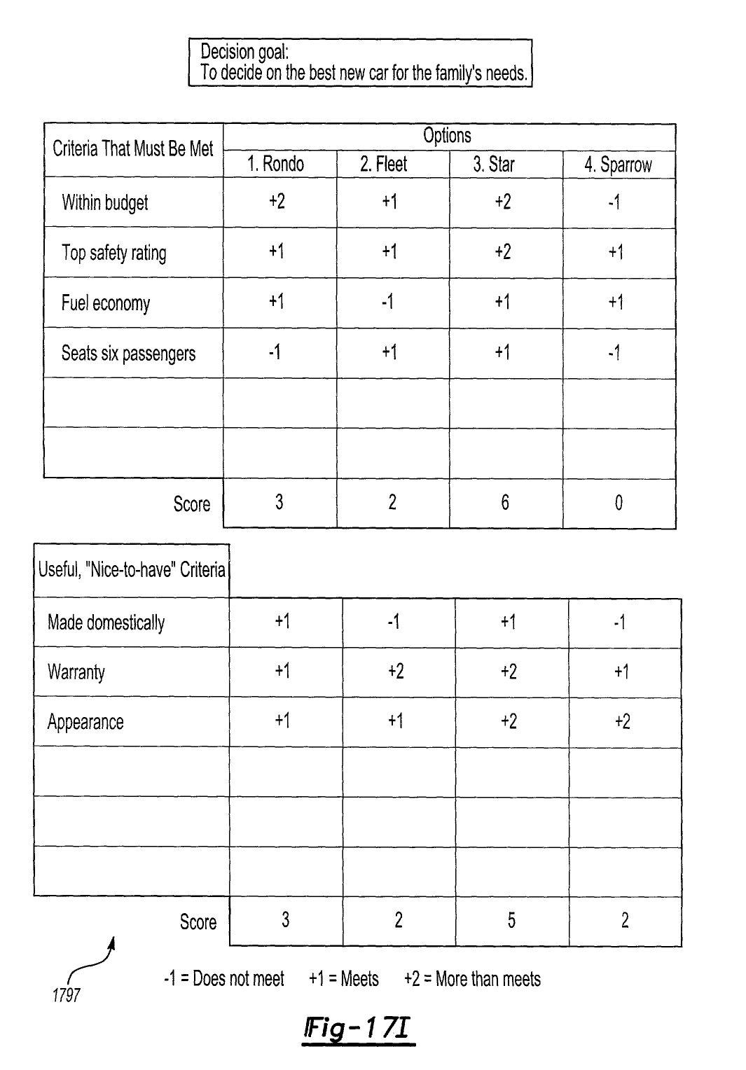

With reference to FIG. 20, the Dealer Project Report Screen 1400 further includes an Attachments Text Box 2000 for assigning an attachment 2010 to the continuous process improvement project (1450) including procedure flowcharts, process steps lists and diagrams.

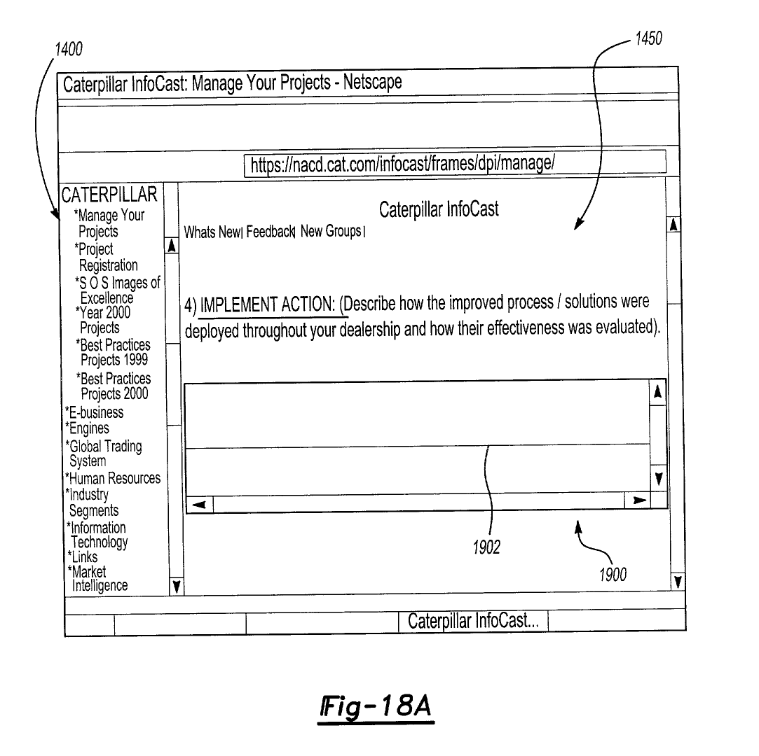

With reference to FIGS. 20 and 21, an attachment 2010 having attachment information is uploaded to a list of attachments 2010 associated with the continuous process improvement project (1450) using a Browse Button 2014 to locate the attachment and a Submit Button 1420 for uploading the attachment. Selecting the attachment 2010 will display a Save As Screen 2100 for saving and viewing the attachment information

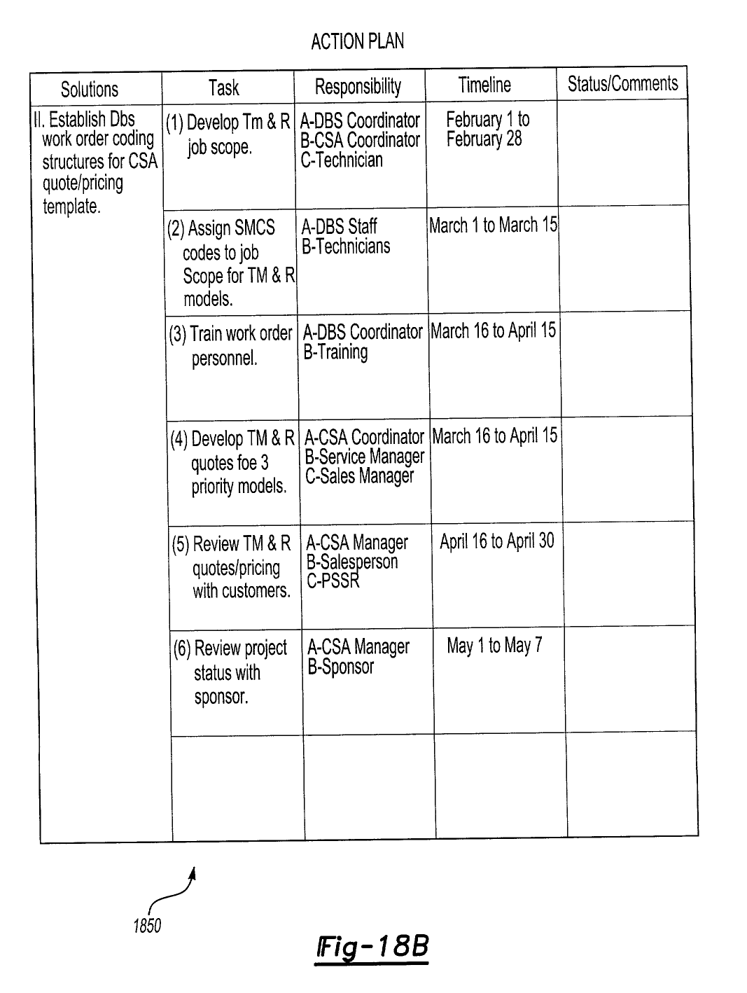

Returning to FIG. 13, an input user 306 selects the Executive Summary Item 1302 on the Manage Dealer Project Menu 1300 to display an Executive Summary Screen 2200, as shown in FIG. 22.

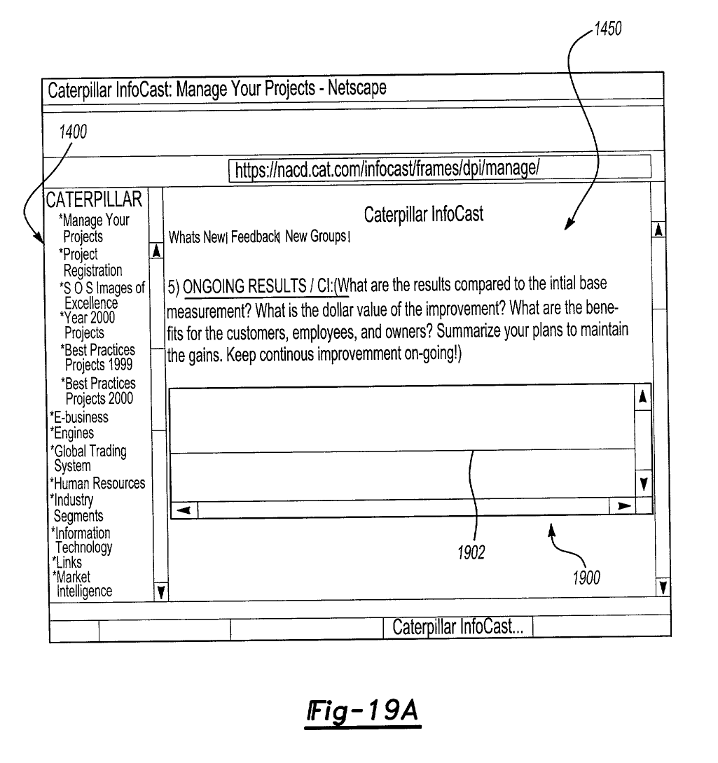

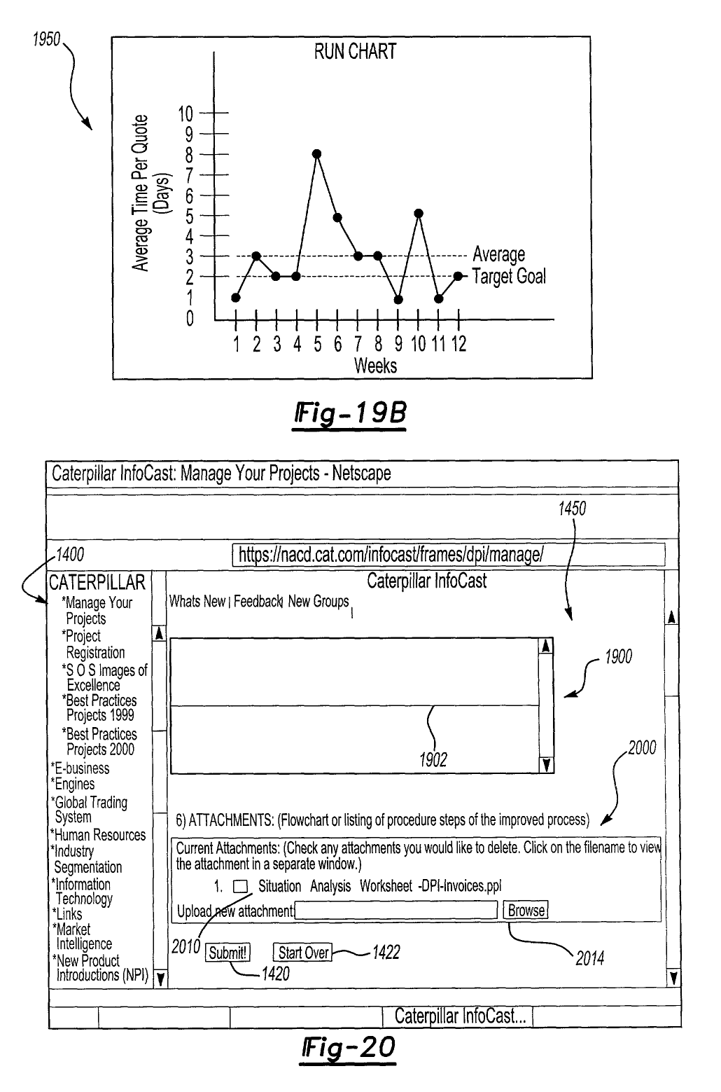

With reference to FIG. 23, the Executive Summary Screen 2200 includes an Executive Summary Text Box 2300 for summary information 2302. The summary information 2302 may be input by an input user 306 or viewed by an access user 308, 310. The summary information 2302 includes a summary problem description, a summary improvement opportunity description and a summary cause verification description. The summary information 2302 further includes a summary selected solution description, a summary solution deployment description, a summary solution effectiveness description and a benefit description. As shown in FIG. 24, the summary information 2302 further includes an Executive Summary Results Text Box 2400. In particular, the Executive Summary Results Text Box 2400 includes a summary comparison description 2402 relating to first former process results 2406 and first new process results 2408 and a summary value description 2410, 2412 relating to monetary value of the first new process results 2408. In addition, where more than one process result is used to track process improvement, the Executive Summary Results Text Box 2400 may include a summary comparison description relating to second former process results and second new process results.

After the summary information is input, the input user 306 selects a Submit Button 2220, to relay the information from the remote location 104, 106, 108 to the central location 110, or a Start Over Button 2222 to clear the Text Box 2400 on the screen 2300 and enter summary information for another project.

Project reports having project information are maintained by the administrator on a best practices database 132 at the central location 110. The best practices database 132 is accessed by selecting the best practices year 806 desired from the Process Improvement Menu 800, as shown in FIG. 8.

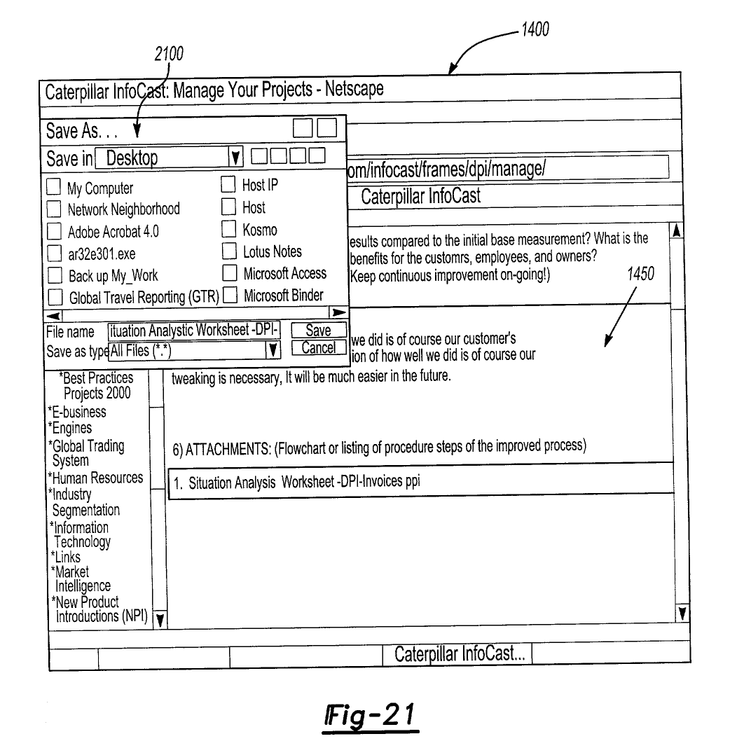

With reference to FIG. 25, a Best Practices Projects Screen 2500 is displayed showing Project Identifier Data Fields 2502 and Category Data Fields 2504.

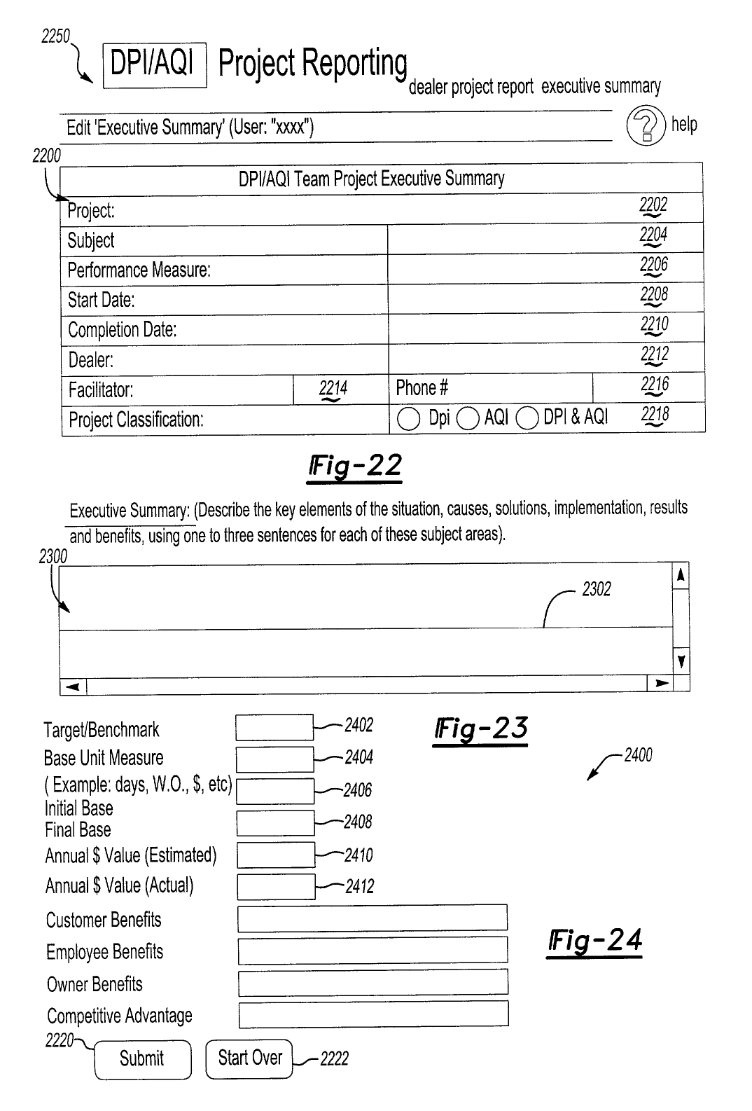

With reference to FIG. 26A, selecting a Project Identifier Data Field (DPI Code) 2502 displays a table or list of dealer projects for the respective project category in which more than five dealers have worked on the same process. Project reports having project information or executive summaries can be viewed by selecting the appropriate key of the Project Link Action Keys 2604, 2606, as shown in FIG. 26B.

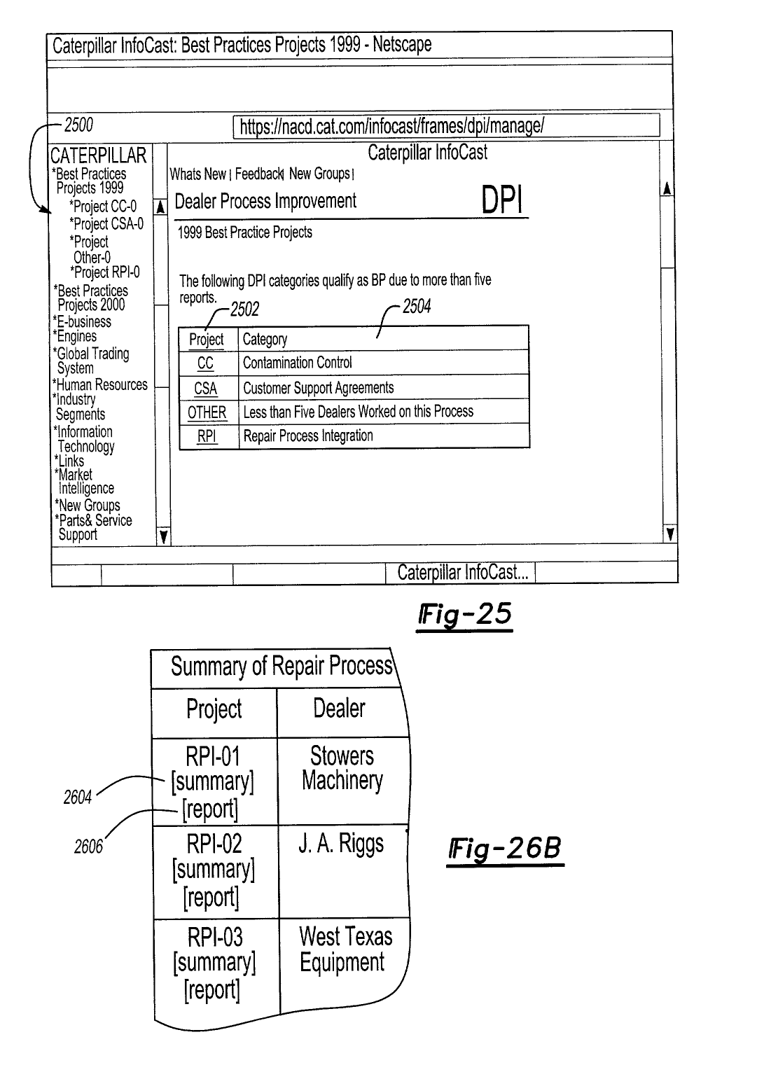

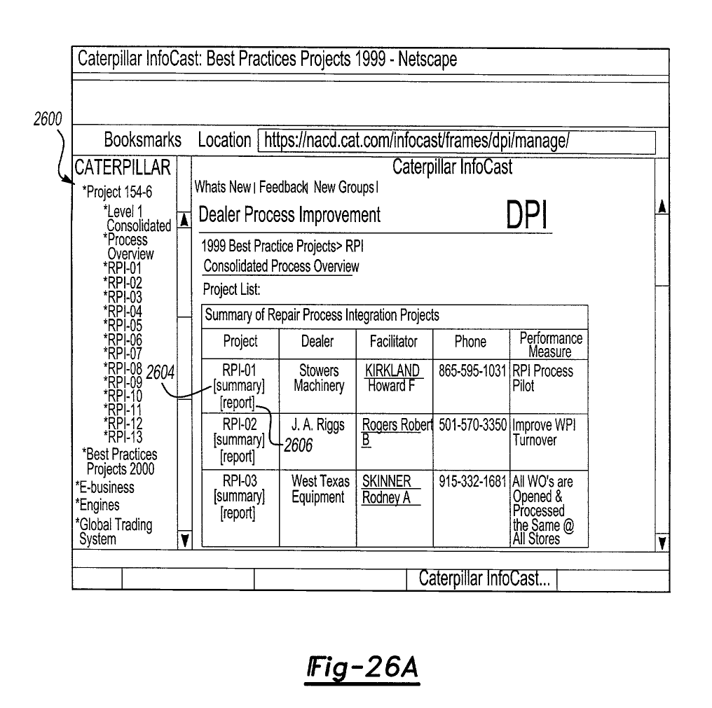

Access users 308, 310 can perform a search of projects according to dealer project attributes in a best practices database 132 from a Search Best Practices Screen 2900, as shown in FIG. 29. Upon entering project attributes and selecting a Submit Button 2914, a Search Results Screen 3000 is displayed, as shown in FIG. 30, showing results of searching the project attributes entered. The results displayed may be one or more projects having the project attributes searched for.

Other aspects, objects and advantages of this invention can be obtained from a study of the drawings, the disclosure and the appended claims.

### INDUSTRIAL APPLICABILITY

The present invention provides a method for sharing information relating to the status of a continuous process improvement project 1450 of a business operation between a plurality of remote sites 102 and a central location 110. For example, the central location may be web server 128 including a global directory server 130 wherein a database 122 resides having data tables 124 and an access control module 128. The dealer acquires access to the database 122 residing on the web server 128 for project registration and accesses a form to input the project information, then relays the project information to the central location 110. An administrator residing at the central location 110 creates a form for the continuous process improvement project report. A dealer facilitator having access rights to the form then enters the project registration information into the form residing at the central location 110. Upon completing information entry, the dealer facilitator submits the information to the central location 110, and the project information is available for sharing with the plurality of remote sites 104, 106, 108.

The present invention allows a team member to access forms and update a project report at the central location 110 with project information. At the conclusion of the project, the dealer project facilitator or a team member with security access creates an executive summary from an executive summary form accessed from the central location 110. Again, the project information is entered on the form in a condensed format and relayed to the central location 110. After the project report and executive summary are created, each can be accessed by access users 308, 310 at any of the plurality of remote locations 104, 106, 108 through a best practices database 132.

What is claimed is:

1. A method for sharing information relating to the status of a continuous process improvement project of a business operation between a plurality of remote sites and a central location, including the steps of:
providing at least one form from the central location on a computer network to the plurality of remote sites over a communications data link;
relaying project information input into the form at one of the plurality of remote sites to the central location over the communications data link; and
providing access to the project information to the plurality of remote sites.

2. A method, as set forth in claim 1, wherein the project information includes at least one project identifier, a project description, a project classification and a dealer project facilitator for performing the continuous process improvement project.

3. A method, as set forth in claim 1, wherein the project information includes a start date, a modification date and a completion date.

4. A method, as set forth in claim 1, wherein the project information includes a dealer name, a facilitator name and a facilitator contact list for providing means for communication with a facilitator.

5. A method, as set forth in claim 1, wherein the project information includes situation assessment information.

6. A method, as set forth in claim 5, wherein the situation assessment information includes a first problem description, a first improvement opportunity description, a current process description, a customer requirement description and a measurement description relating to measuring improvement resulting from the continuous process improvement project.

7. A method, as set forth in claim 1, wherein the project information includes causal information.

8. A method, as set forth in claim 7, wherein the causal information includes a cause identification description, a cause analysis description, a first cause verification description, at least one symptom description and at least one root cause description relating to each at least one symptom description.

9. A method, as set forth in claim 1, wherein the project information includes solution information.

10. A method, as set forth in claim 1, wherein the project information includes solution implementation information.

11. A method, as set forth in claim 1, wherein the project information includes continuous process improvement information.

12. A method, as set forth in claim 11, wherein the continuous process improvement information includes a comparison description relating to first former process results and first new process results, a value description relating to monetary value of the first new process results, a benefit description and a maintenance plan description.

13. A method, as set forth in claim 1, wherein the project information includes attachment information for including one of a procedure flowchart, a process steps list and a diagram.

14. A method, as set forth in claim 1, wherein the project information includes summary information relating to the continuous process improvement project.

15. A method, as set forth in claim 14, wherein the summary information includes a summary comparison description relating to first former process results and first new process results, a summary value description relating to monetary value of the first new process results.

16. A method for sharing information relating to the status of a continuous process improvement project of a business operation between a plurality of remote sites, including the steps of:
providing at least one form from a central location on a computer network to the plurality of remote sites over a communications data link;
relaying project information input into the form by an input user at one of the plurality of remote sites to the central location over the communications data link;
providing access to the project information to a plurality of access users at the plurality of remote sites; and
providing a graphical user interface for operation by the input user and the plurality of access users.

17. A method, as set forth in claim 16, including the step of providing a login page screen for allowing the input user and remote users to gain access to the information;

18. A method, as set forth in claim 16, including the step of providing a project registration screen for allowing the input user and remote users to register the continuous process improvement project.

19. A method, as set forth in claim 16, including the step of providing an administrator report screen for defining at least one report.

20. A method, as set forth in claim 16, including the step of providing a dealer project report screen for allowing the input user and remote users to input and access project information.

21. A method, as set forth in claim 16, including the step of using at least one tool to analyze current process information and generate project information.

22. A method, as set forth in claim 21, including the step of providing the at least one tool in a corresponding form relayed from the central location to the plurality of remote sites over a communications data link.

23. A method, as set forth in claim 21, including the step of providing a situation assessment text box for displaying an opportunity for improvement.

24. A method, as set forth in claim 21, wherein the at least one tool is one of a gap analysis tool, a process map tool, a statement worksheet tool, a data decision worksheet tool and an involvement worksheet tool.

25. A method, as set forth in claim 21, including the step of providing a determine causes text box for displaying causes of an opportunity for improvement.

26. A method, as set forth in claim 21, wherein the at least one tool is one of a cause and effect tool and a pareto chart tool.

27. A method, as set forth in claim 21, including the step of providing a target solutions text box for displaying solutions to an opportunity for improvement.

28. A method, as set forth in claim 21, wherein the at least one tool is one of a redefine worksheet tool, an impact and effort table tool, an impact and effort grid tool, a solution and impact tool, a second process map tool, a balance sheet tool, a weighted voting tool and a criteria screen tool.

29. A method, as set forth in claim 21, including the step of providing an implementation text box for displaying an improved process.

30. A method, as set forth in claim 21, wherein the at least one tool is an action plan tool.

31. A method, as set forth in claim 21, including the step of providing a continuous improvement text box for displaying maintenance of an improved process.

32. A method, as set forth in claim 21, wherein the at least one tool is a run chart tool.

33. A method, as set forth in claim 16, including the step of providing an executive summary screen for displaying a continuous process improvement project summary.

34. A method, as set forth in claim 16, including the step of providing an executive summary text box for displaying an executive summary.

35. A method, as set forth in claim 16, including the step of providing an executive summary results text box for displaying results of the continuous process improvement project.

36. A method, as set forth in claim 16, including the step of providing a best practices projects screen for accessing best practices information.

37. A method, as set forth in claim 16, including the step of providing a search best practices screen for searching for dealer project attributes and providing a list of projects having the dealer project attributes.

38. A method, as set forth in claim 16, including the step of providing a team members screen for allowing an administrator and a facilitator to manage a dealer project's team.

39. A method, as set forth in claim 16, including the step of providing a manage best practice projects screen for allowing an administrator to create an administrator report.

40. A method, as set forth in claim 16, including the step of providing at least one screen for allowing an administrator to manage the project information of at least one continuous process improvement project.

41. A method for sharing information relating to the status of a continuous process improvement project of a business operation between a plurality of remote sites, including the steps of:
storing at least one form at a central location having a web server including a global directory server wherein a database resides having data tables and an access control module;
providing the at least one form from the central location on a computer network to the plurality of remote sites over a communications data link for recording the status of the continuous process improvement project by an input user;
relaying project information input into the forms by the input user at the remote site relating to the continuous process improvement projects to the central location over the communications data link; and
providing access to the project information to the plurality of remote sites.

42. A method, as set forth in claim 41, further including the steps of:
selecting a subset of continuous process improvement projects as a function of project parameters from a plurality of process improvement projects stored in the data tables at the central location by at least one access user from at least one of the plurality of remote sites;
displaying the project information relating to only the subset of continuous process improvement projects relayed from the central location and selected by the at least one access user.

43. A system for sharing information relating to the status of a continuous process improvement project of a business operation between a plurality of remote sites and a central location comprising:
a central computer at the central location for storing a form; and
a remote computer at each of the plurality of remote sites for accessing the form from the central computer and relaying project information input into the form by an input user at one of the plurality of remote sites to the central computer, the central computer being adapted to collect, store and relay the project information to the remote computer at each of the plurality of remote sites.

44. A system, as set forth in claim 43, wherein the project information includes at least one project identifier, a project description, a project classification and a dealer project facilitator for performing the continuous process improvement project.

45. A system, as set forth in claim 43, wherein the project information includes a start date, a modification date and a completion date.

46. A system, as set forth in claim 43, wherein the project information includes a dealer name, a facilitator name and a facilitator contact list for providing means for communication with a facilitator.

47. A system, as set forth in claim 43, wherein the project information includes situation assessment information.

48. A system, as set forth in claim 47, wherein the situation assessment information includes a first problem description, a first improvement opportunity description, a current process description, a customer requirement description and a measurement description relating to measuring improvement resulting from the continuous process improvement project.

49. A system, as set forth in claim 43, wherein the project information includes causal information.

50. A system, as set forth in claim 49, wherein the causal information includes a cause identification description, a cause analysis description, a first cause verification description, at least one symptom description and at least one root cause description relating to each at least one symptom description.

51. A system, as set forth in claim 43, wherein the project information includes solution information.

52. A system, as set forth in claim 51, wherein the solution information includes at least one potential solution description and a first selected solution description for creating an improved process.

53. A system, as set forth in claim 43, wherein the project information includes solution implementation information.

54. A system, as set forth in claim 53, wherein the solution implementation information includes a first solution deployment description and a first solution effectiveness description.

55. A system, as set forth in claim 43, wherein the project information includes continuous process improvement information.

56. A system, as set forth in claim 55, wherein the continuous process improvement information includes a comparison description relating to first former process results and first new process results, a value description relating to monetary value of the first new process results, a benefit description and a maintenance plan description.

57. A system, as set forth in claim 43, wherein the project information includes attachment information for including one of a procedure flowchart, a process steps list and a diagram.

58. A system, as set forth in claim 43, wherein the project information includes summary information relating to the continuous process improvement project.

59. A system, as set forth in claim 58, wherein the summary information includes a summary comparison description relating to first former process results and first new process results, a summary value description relating to monetary value of the first new process results.

60. A system for sharing information relating to the status of a continuous process improvement project of a business operation between a plurality of remote sites and a central location comprising:
a central computer at the central location for storing a form; and
a remote computer at each of the plurality of remote sites for accessing the form from the central computer and relaying project information input into the form by an input user at one of the plurality of remote sites to the central computer, the central computer being adapted to collect, store and relay the project information to the remote computer at each of the plurality of remote sites for a plurality of access users; and
a graphical user interface for operation by the input user and the plurality of access users.

61. A system, as set forth in claim 60, including a login page screen for allowing the input user and remote users to gain access to the information;

62. A system, as set forth in claim 60, including a project registration screen for allowing the input user and remote users to register the continuous process improvement project.

63. A system, as set forth in claim 60, including an administrator report screen for defining at least one report.

64. A system, as set forth in claim 60, including a dealer project report screen for allowing the remote users to input and access project information.

65. A system, as set forth in claim 60, including at least one tool to analyze current process information and generate project information.

66. A system, as set forth in claim 65, including at least one tool in a corresponding form relayed from the central location to the plurality of remote sites over a communications data link.

67. A system, as set forth in claim 60, including a situation assessment text box for displaying an opportunity for improvement.

68. A system, as set forth in claim 60, wherein the at least one tool is one of a gap analysis tool, a process map tool, a statement worksheet tool, a data decision worksheet tool and an involvement worksheet tool.

69. A system, as set forth in claim 60, including a determine causes text box for displaying causes of an opportunity for improvement.

70. A system, as set forth in claim 60, wherein the at least one tool is one of a cause and effect tool and a pareto chart tool.

71. A system, as set forth in claim 60, including a target solutions text box for displaying solutions to an opportunity for improvement.

72. A system, as set forth in claim 60, wherein the at least one tool is one of a redefine worksheet tool, an impact and effort table tool, an impact and effort grid tool, a solution and impact tool, a second process map tool, a balance sheet tool, a weighted voting tool and a criteria screen tool.

73. A system, as set forth in claim 60, including an implementation text box for displaying an improved process.

74. A system, as set forth in claim 60, wherein the at least one tool is an action plan tool.

75. A system, as set forth in claim 60, including a continuous improvement text box for displaying maintenance of an improved process.

76. A system, as set forth in claim 60, wherein the at least one tool is a run chart tool.

77. A system, as set forth in claim 60, including an executive summary screen for displaying a continuous process improvement project summary.

78. A system, as set forth in claim 60, including an executive summary text box for displaying an executive summary.

79. A system, as set forth in claim 60, including an executive summary results text box for displaying results of the continuous process improvement project.

80. A system, as set forth in claim 60, including a best practices projects screen for accessing best practices information.

81. A system, as set forth in claim 60, including a search best practices screen for searching for dealer project attributes and providing a list of projects having the dealer project attributes.

82. A system, as set forth in claim 60, including a team members screen for allowing an administrator and a facilitator to manage a dealer project's team.

83. A system, as set forth in claim 60, including a manage best practice projects screen for allowing an administrator to create an administrator report.

84. A system, as set forth in claim 60, including at least one screen for allowing an administrator to manage the project information of at least one continuous process improvement project.

85. A system for sharing information relating to the status of a continuous process improvement project of a business operation between a plurality of remote sites and a central location, comprising:
a central computer at the central location for storing a form; and
a remote computer at each of the plurality of remote sites for accessing the form from the central computer and relaying project information input into the form by an input user at one of the plurality of remote sites to the central computer, the central computer being adapted to collect, store and relay the project information to the remote computer at each of the plurality of remote sites for access by an access user, wherein the central computer provides a web server including a global directory server wherein a database resides having data tables and an access control module.

86. A system, as set forth in claim 85, wherein the central computer provides the form from the central location on a computer network to the remote computer at the plurality of remote sites over a communications data link for recording the status of the continuous process improvement project by the input user.

87. A system, as set forth in claim 85, wherein the remote computer at the plurality of remote sites relays project information input into the forms by the input user at the plurality of remote sites to the central computer at the central location over the communications data link.

88. A system, as set forth in claim 85, wherein the central computer at the central location relays project information to the remote computer at each of the plurality of remote sites when accessed by the access user.

89. A computer program product for sharing information relating to the status of a continuous process improvement project of a business operation between a plurality of remote sites and a central location over a communications data link, comprising:
computer readable program code means for selecting a subset of continuous process improvement projects as a function of project parameters from a plurality of process improvement projects stored in the data tables at the central location by at least one access user from at least one of the plurality of remote sites;
computer readable program code means for displaying the project information relating to only the subset of continuous process improvement projects relayed from the central location and selected by the at least one access user.

90. A computer program product, as set forth in claim 89, wherein the project parameters includes at least one project identifier, a project description, a project classification and a dealer project facilitator for performing the continuous process improvement project
